(19) United States
(12) Patent Application Publication
(10) Pub. No.: US 2025/0278033 A1
(43) Pub. Date: Sep. 4, 2025

(54) RESIN PARTICLES AND METHOD OF MANUFACTURING SAME

(71) Applicants: Kohsuke SATOH, Kanagawa (JP); Taro ARAKI, Kanagawa (JP); Akira TANAKA, Kanagawa (JP); Hiroki ARAYA, Kanagawa (JP)

(72) Inventors: Kohsuke SATOH, Kanagawa (JP); Taro ARAKI, Kanagawa (JP); Akira TANAKA, Kanagawa (JP); Hiroki ARAYA, Kanagawa (JP)

(21) Appl. No.: 19/064,757

(22) Filed: Feb. 27, 2025

(30) Foreign Application Priority Data
Feb. 29, 2024 (JP) 2024-030304

(51) Int. Cl. G03G 9/09; G03G 9/08; G03G 9/087; G03G 9/113

(52) U.S. Cl. CPC G03G 9/0902; G03G 9/0804; G03G 9/08755; G03G 9/1138

(57) ABSTRACT

Resin particles are provided that include magnesium and sodium as metal elements. A magnesium content in the resin particles measured by fluorescent X-ray analysis is lower than a sodium content in the resin particles measured by the fluorescent X-ray analysis.

### CROSS-REFERENCE TO RELATED APPLICATIONS

This patent application is based on and claims priority pursuant to 35 U.S.C. § 119(a) to Japanese Patent Application No. 2024-030304, filed on Feb. 29, 2024, in the Japan Patent Office, the entire disclosure of which is hereby incorporated by reference herein.

### BACKGROUND

### Technical Field

The present disclosure relates to resin particles and a method of manufacturing the same.

### Related Art

Resin particles are widely utilized as toner for image forming devices such as multifunction peripherals (MFPs) and printers in various places such as offices. For example, to reduce the environmental impact of toner, a reduction of the power consumption by improving the fixability of the toner at low temperatures, a reduction of the energy during production, the use of biomass (plant)-derived resins as binder resins, the use of recycled raw materials as binder resins, and the like are being considered. Specifically, because of the increasing importance of resource and energy conservation and the need for recycling resources, there is an increasing demand for the use of recycled materials such as polyethylene terephthalate and polybutylene terephthalate as binder resins.

### SUMMARY

Embodiments of the present invention provide resin particles that include magnesium and sodium as metal elements. A magnesium content in the resin particles measured by fluorescent X-ray analysis is lower than a sodium content in the resin particles measured by the fluorescent X-ray analysis.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present invention, resin particles having excellent fixability and electrostatic properties are provided.

Embodiments of the present invention are described below.

(1) Resin particles according to embodiments of the present invention include magnesium (Mg) and sodium (Na) as metal elements, and a Mg content (mass %) in the resin particles measured by fluorescent X-ray analysis is lower than a Na content (mass %) in the resin particles measured by the fluorescent X-ray analysis.

The above-mentioned requirements can be achieved, when resin particles are manufactured by a method including a step of preparing a solution by dissolving or dispersing a resin in an organic solvent, a step of adding water to the solution to cause phase inversion from a water-in-oil dispersion liquid to an oil-in-water dispersion liquid, and an aggregation step of aggregating fine particles in the oil-in-water dispersion liquid by using an aggregating agent and terminating the aggregation at a predetermined time by using a terminating agent, by weakening stirring during the aggregation step. For example, the stirring may be weakened by using anchor blades that have low vertical convection as the stirring blades, or not providing baffles in the stirring tank.

By weakening the stirring, the amount of the aggregating agent that is Mg used to form resin particles can be reduced, and the liquid temperature can be lowered. The amount of use of Mg is small, and thus, the electrostatic properties, the environmental anisotropy, and the transferability can be improved. On the other hand, by weakening the stirring, the aggregation cannot be terminated by the stirring force, and thus, the amount of use of the terminating agent that is Na increases. When the amount of use of Na increases, the state of aggregation of the resin particles can be controlled, undesired fusion of the resin particles can be prevented, and the particle size distribution is improved.

From the above, in the present embodiment, a Mg content (mass %) in the resin particles measured by fluorescent X-ray analysis is lower than a Na content (mass %) in the resin particles measured by fluorescent X-ray analysis.

When the stirring in the aggregation step is strong, the amount of aggregating agent increases, the liquid temperature is high, and the stirring time also increases. Since the terminating agent can terminate the aggregation under stirring, the amount of use of terminating agent can be reduced. From the above, when the stirring is strong, the amount of the aggregating agent that is Mg is greater than the amount of the terminating agent that is Na.

### (Measurement Method)

In the present embodiment, an example of the fluorescent X-ray analysis includes a quantitative analysis of metal ions by using an X-ray fluorescence device (ZSX PRIMUS IV (manufactured by Rigaku Corporation)). A sample of the resin particles to be measured is not limited to have a particular shape. However, it is easy to handle a sample that is molded into a pellet shape or a sheet shape by using a general pressure molding device or the like. For example, a sample is placed in a molding die for tablets having a diameter of 15 mm and pressed for 1 minute under a load of 6 MPa, to obtain a pellet tablet of resin particles having a thickness of about 2 mm. The obtained pellet tablet is placed in a sample holder of an X-ray fluorescence device and quantitatively analyzed (for example, at a tube voltage of 50 kV and a tube current of 30 mA), to detect metal elements contained in the sample. When an external additive is added to the resin particles, the amount of metal elements is measured after removing the external additive from the resin particles. Any method can be used to remove the external additive. For example, 3.75 g of resin particles are added to 50 ml of a surfactant (e.g., NOIGEN ET-165) diluted to 0.5%, and the mixture is stirred in a ball mill. Subsequently, ultrasonic energy is applied (for example, at 40 W, 5 minutes) by using an ultrasonic homogenizer. After the ultrasonic waves are applied, the resin dispersion solution is centrifuged and then, filtered to collect the precipitate. At this time, the above-described operations are repeated until the supernatant liquid obtained after centrifugation is transparent. Afterwards, the precipitate is dried in a thermostatic chamber to obtain a sample and the amount of metal elements in the sample is measured.

(2) Resin particles according to embodiments of the present invention are the resin particles according to (1) described above, in which the Mg content in the resin particles is 0.05 mass % or more and 0.30 mass % or less.

Mg is an aggregating agent. In a case where the resin particles form a core-shell structure, when the content of Mg is 0.05 mass % or more, the particle size distribution of the core particles is sharp during a core aggregation process in an emulsion aggregation method. Further, in a shell aggregation process, shell formation easily occurs on the core. When the content of Mg is 0.30 mass % or less, the aggregation properties are appropriate during the core aggregation process. Therefore, it is easy to adjust the particle size distribution and a sharp particle size distribution is obtained. In the shell aggregation process, hetero-aggregation to the core is more likely to occur, while homo-aggregation between shells is less likely to occur, and thus, poor shell formation can be prevented.

### (Amount)

The Mg content in the resin particles is preferably 0.1 mass % or more and 0.25 mass % or less, and more preferably 0.12 mass % or more and 0.20 mass % or less.

### (Type)

Mg is a divalent aggregating agent. Other examples of aggregating agents include monovalent Na and potassium (K), and trivalent aluminum (Al). However, monovalent Na and K have inferior aggregation properties compared to divalent Mg, and the amount required for aggregation increases. Further, it may be difficult to adjust the particle diameter. The aggregation properties of trivalent Al are too strong, and thus, it is not easy to adjust the particle diameter. This tendency is particularly noticeable in systems where the stirring is weak.

(3) Resin particles according to embodiments of the present invention are the resin particles according to (1) or (2) described above, in which the Na content in the resin particles is 0.10 mass % or more and 0.40 mass % or less.

Na is a terminating agent, and when the content of Na is 0.10 mass % or more, the aggregation can be terminated in a suitable manner. When the content of Na is 0.40 mass % or less, the shape control can be suitably performed during fusion. Further, suppressing an increase in the total amount of metals reduces the risk of adversely affecting the resistance and charging.

### (Amount)

The Na content in the resin particles is preferably 0.15 mass % or more and 0.35 mass % or less, and more preferably 0.20 mass % or more and 0.30 mass % or less.

The sum of the Mg content (mass %) and the Na content (mass %) is preferably 0.20 to 0.80 mass %, and more preferably 0.20 to 0.42 mass %.

### (Type)

In contrast to the divalent Mg serving as an aggregating agent, a monovalent terminating agent is preferred, and Na is preferred.

(4) Resin particles according to embodiments of the present invention are the resin particles according to any one of (1) to (3) described above, in which a concentration of radioactive carbon isotope ¹⁴C in the resin particles is 10.8 pMC or more.

### (Concentration of Radioactive Carbon Isotope ¹⁴C)

The concentration of the radioactive carbon isotope ¹⁴C (may also be referred to as “¹⁴C concentration”) of the resin particles is 10.8 pMC or more, preferably 11 pMC or more, more preferably 20 pMC or more, and even more preferably 30 pMC or more. When the concentration of the radioactive carbon isotope ¹⁴C in the resin particles is 10.8 pMC or more, it is generally determined that a later-described biomass degree is high, which can achieve a reduction of the impact on the environment.

¹⁴C exists in nature (i.e., in the atmosphere), is absorbed by plants through photosynthesis while the plants are active, and is in equilibrium (107.5 pMC) with the ¹⁴C concentration in the atmosphere. However, when the biological activities of a living organism stop, absorption through photosynthesis ceases, and the ¹⁴C concentration decreases in accordance with the half-life of ¹⁴C, which is 5,730 years. In fossil resources originating from living organisms, tens of thousands to hundreds of millions of years have elapsed since the biological activities of the living organism stopped, so that the ¹⁴C concentrations are almost not detectable.

Here, “pMC” is the abbreviation of “percent Modern Carbon”, and the ratio (¹⁴C/¹²C) of ¹⁴C to ¹²C in biomass of the year 1950 is defined as 100 pMC. However, because the current concentration of carbon-14 (¹⁴C) in the atmosphere is increasing every year, this value is multiplied by a coefficient for correction purposes. A coefficient appropriate for the desired year is used as the correction coefficient.

The ¹⁴C concentration can also be expressed as a biomass degree calculated by Equation (1) below.

$$Biomass degree ( \% ) = {}^{14} C concentration ( pMC ) / 107.5 \times 100 \qquad Equation ( 1 )$$

When the ¹⁴C concentration is 10.8 pMC or more, the biomass degree is 10% or more. A biomass degree of 10% or more is a concentration desired from the viewpoint of carbon neutrality.

A method of measuring the ¹⁴C concentration is not limited and can be appropriately selected according to a purpose, but radiocarbon dating is particularly preferred.

A measurement procedure for radiocarbon dating includes burning the resin particles and reducing the carbon dioxide (CO₂) in the resin particles to obtain graphite (C). The ¹⁴C concentration of graphite is measured by using accelerator mass spectrometry (AMS, manufactured by BetaAnalytic). A measurement using such AMS technique is disclosed in Japanese Patent No. 4050051, for example.

(5) Resin particles according to embodiments of the present invention are the resin particles according to any one of (1) to (4) described above, including polyethylene terephthalate (PET) or polybutylene terephthalate (PBT).

### [PET or PBT]

The PET or PBT is contained in the resin particles mainly for reducing the environmental impact.

The type of PET or PBT is not limited and can be appropriately selected according to a purpose. For example, recycled products, fiber waste not meeting specifications, or pellets can be used. However, from the viewpoint of reducing the environmental impact, recycled products (may also be referred to as “recycled resin”) processed into flakes are preferable.

The molecular weight distribution, the composition, the manufacturing method, and the shape at use of PET and PBT are not limited and can be appropriately selected according to a purpose.

The weight average molecular weight (Mw) of PET or PBT is not limited and can be appropriately selected according to a purpose, but is preferably 30,000 to 100,000.

The analytical method and the calculation method for determining the content of PET or PBT in the resin particles are not limited, and a general calculation method can be used to determine the blended amount of PET. An example of the analytical method and the calculation method for determining the content of PET or PBT includes separating PET or PBT from the resin particles by gel permeation chromatography (GPC) or the like, and subjecting each of the separated components to the analytical procedure described below, to calculate the mass ratio of the constituent components of the resin particles.

Further, quantitative analysis may also be performed as follows. A gas chromatography/mass spectrometry (GC/MS) method is used at 300° C. with a reaction reagent (e.g., 10% tetramethyl ammonium hydroxide (TMAH)/methanol solution) to subject the ester binding moieties in the resin particles to methylation and estimate the main constituent components from the soft decomposition in the methylation. Subsequently, a calibration curve of the intensity in a total ion current chromatogram (TICC) is drawn, to quantitatively analyze PET or PBT.

The components can each be separated by GPC using the following method, for example.

In the GPC measurement using tetrahydrofuran (THF) as a mobile phase, the eluate is fractionated by using a fraction collector or the like, and fractions corresponding to the desired molecular weight portion within the full surface integral of the elution curve are collected.

The collected eluate is concentrated and dried using an evaporator or the like. Subsequently, the solid content is dissolved in a deuterated solvent such as deuterated chloroform or deuterated THE, and subjected to 1H-NMR measurement. The constituent monomer ratio of the resin in the eluted components is calculated from the integrated ratio of each element.

In another method, the eluate may be concentrated, and then, hydrolyzed with sodium hydroxide or the like, to qualitatively and quantitatively analyze the decomposition products by high-performance liquid chromatography (HPLC) or the like and calculate the constituent monomer ratio.

The content of PET or PBT is not limited and can be appropriately selected according to a purpose, but is preferably 5 parts by mass to 70 parts by mass, and more preferably 10 parts by mass to 50 parts by mass, with respect to 100 parts by mass of the resin particles. When the content of PET or PBT is 70 parts by mass or less with respect to 100 parts by mass of the resin particles, the obtained product has fixability at low temperatures. When the content of PET or PBT is 5 parts by mass or more with respect to 100 parts by mass of the resin particles, an effect of reducing the environmental impact can be exerted and resin particles having excellent particle size distribution can be obtained. When the content of PET or PBT is within the above-mentioned more preferred range, it is advantageous in that both the reduction in the environmental impact of the resin particles and the improvement in the particle size distribution can be achieved.

Another example of a technique for separating the components contained in the resin particles when analyzing the resin particles will be described in detail. First, 1 g of the resin particles is added to 100 mL of THE, and the mixture is stirred for 30 minutes at 25° C. to obtain a solution in which the soluble components are dissolved. The solution is filtered through a membrane filter having an opening of 0.2 μm to obtain a portion of the resin particles soluble in THF. Next, the soluble portion is dissolved in THF to prepare a sample for GPC measurement, and the sample is injected into a GPC used for measuring the molecular weight of each of the above-mentioned resins. On the other hand, a fraction collector is placed at an eluate discharge port of the GPC to collect the eluate at predetermined counts. The eluate is collected for each 5% of area ratio from the elution start in the elution curve (the rise of the curve). Next, for each elution fraction, 30 mg of the sample is dissolved in 1 mL of deuterated chloroform, and 0.05 vol % of tetramethylsilane (TMS) is added as a standard substance. The solution is filled into a glass tube for NMR measurement having a diameter of 5 mm, and a nuclear magnetic resonance device (JNM-AL400 manufactured by JEOL Ltd.) is used at a temperature of 23° C. to 25° C. at 128 integrations to obtain a spectrum. The monomer composition and constituent ratio of the PET resin or the like contained in the resin particles can be determined from the peak integral ratio of the obtained spectrum.

(6) The resin particles according to embodiments of the present invention are the resin particles according to any one of (1) to (5) described above, including a biomass-derived resin and polyethylene terephthalate or polybutylene terephthalate, and in which a content of the polyethylene terephthalate or polybutylene terephthalate in the resin particles is greater than a content of the biomass-derived resin.

### (Biomass-Derived Resin)

The resin particles preferably contain a biomass-derived resin. The biomass-derived resin may be included in at least one of an amorphous resin, a non-crystalline resin, and a crystalline resin described below.

A biomass-derived resin is a resin containing plant-derived compounds as raw materials. The biomass-derived resin may be contained in a crystalline resin described below, or in an amorphous resin, or may be contained in other components such as a release agent. In the resin particles, by adjusting the ratio of petroleum-derived components to plant-derived components in alcohol components and acid components included in the resin particles, an environmental compatibility ratio, which will be described below, and the toner quality when the resin particles are applied to a toner can be adjusted.

In recent years, there is a strong demand for toners that contain biomass-derived resins and are more environmentally friendly, while having improved functions as toners. Many of the constituent monomers of petroleum-based resins have an aromatic ring backbone. When it is desired that the biomass-derived resin has excellent quality in terms of fixability at low temperatures, aliphatic monomers not having an aromatic ring backbone are often used as the constituent monomers of the biomass-derived resin, which have large structural differences and a poor particle size distribution during the manufacturing process of the resin particles.

In response to the above-described situation, the resin particles contain PET or PBT having an aromatic ring backbone to reduce the impact of such structural differences in the biomass-derived resin while improving environmental compatibility. Further, in a case where a metal salt is used to aggregate resin particles during the manufacturing of the resin particles, when a trivalent or higher metal salt having a high degree of cross-linking is used, aggregation properties are likely to change, and the particle size distribution deteriorates. By using a divalent metal salt to aggregate components in a mild manner, resin particles having a good particle size distribution can be obtained.

Therefore, the resin particles according to the present embodiment can reduce the environmental impact and provide an excellent particle size distribution.

As described above, in addition to PET or PBT, the resin particles preferably contain at least one of an amorphous resin, a non-crystalline resin, and a crystalline resin, and more preferably contain an amorphous resin, a non-crystalline resin, and a crystalline resin.

The total content of the biomass-derived resin and PET or PBT, with respect to the total mass of the resin particles, is preferably 50 mass % or more, more preferably 60 mass % or more, and even more preferably 80 mass % or more.

As described above, the resin particles contain PET or PBT and a biomass-derived resin, and it is preferable that the PET or PBT is contained in a larger amount than the biomass-derived resin.

(7) Resin particles according to embodiments of the present invention are the resin particles according to any one of (1) to (6) described above, having a core-shell structure, and the core-shell structure includes a shell layer including at least a sulfonate group.

When a sulfonate group is provided, an effect on the electrostatic performance and the heat-resistant storage stability is expected. In the present embodiment, a polyester resin containing a sulfonate group is preferably used.

### (Polyester Resin Containing Sulfonate Group)

An alcohol and a carboxylic acid used in the synthesis of the polyester resin containing a sulfonate group are not limited. Examples of the constituent components include the following components.

### (Diol)

Examples include, but are not limited to, aliphatic diols such as ethylene glycol, 1,2-propylene glycol, 1,3-propylene glycol, 1,4-butanediol, 3-methyl-1,5-pentanediol, 1,6-hexanediol, 1,8-octanediol, 1,10-decanediol, and 1,12-dodecanediol; diols having an oxyalkylene group such as diethylene glycol, triethylene glycol, dipropylene glycol, polyethylene glycol, polypropylene glycol, and polytetramethylene glycol; alicyclic diols such as 1,4-cyclohexanedimethanol and hydrogenated bisphenol A; diols obtained by adding alkylene oxides such as ethylene oxide, propylene oxide, and butylene oxide to alicyclic diols; bisphenols such as bisphenol A, bisphenol F, and bisphenol S; and alkylene oxide adducts of bisphenols such as bisphenol ethylene oxide and bisphenols to which alkylene oxides such as propylene oxide and butylene oxide are added.

### (Dicarboxylic Acid)

The dicarboxylic acid is not particularly limited, can be appropriately selected according to a purpose, and examples thereof include, but are not limited to, aliphatic dicarboxylic acids and aromatic dicarboxylic acids. Further, anhydrides, lower alkyl esters (number of carbon atoms from 1 to 3), or halides of these dicarboxylic acids may be used.

The aliphatic dicarboxylic acid is not particularly limited, can be appropriately selected according to a purpose, and examples thereof include, but are not limited to, succinic acid, adipic acid, sebacic acid, dodecanedioic acid, maleic acid, and fumaric acid.

The aromatic dicarboxylic acid is not particularly limited, can be appropriately selected according to a purpose, and examples thereof include, but are not limited to, phthalic acid, isophthalic acid, terephthalic acid, and naphthalenedicarboxylic acid. Among these, aliphatic dicarboxylic acids having 4 to 12 carbon atoms are preferred.

These dicarboxylic acids may be used alone or in combination of two or more types.

### (Trivalent or Higher Acid and Alcohol)

The above-mentioned trivalent or higher acid and alcohol may also be used. The trivalent or higher acid and alcohol are not particularly limited, can be appropriately selected according to a purpose, and examples thereof include, but are not limited to, glycerin, trimethylolethane, trimethylolpropane (TMP), pentaerythritol, sorbitol, dipentaerythritol, trimellitic acid (TMA), and pyromellitic acid.

### (Monomer Containing Sulfonate Group)

In the synthesis of the polyester resin containing a sulfonate group, a monomer containing a sulfonate group is used. Examples of the monomer containing a sulfonate group include, but are not limited to, monomers containing aromatic sulfonate groups and monomers containing aliphatic sulfonate groups. Among these, monomers containing aromatic sulfonate groups having divalent or higher carboxylic acids are preferred.

Examples of aromatic dicarboxylic acids having sulfonate groups include, but are not limited to, 5-sulfoisophthalic acid, 2-sulfoisophthalic acid, 4-sulfoisophthalic acid, 4-sulfo-2,6-naphthalenedicarboxylic acid, and sulfonates of ester-forming derivatives of the mentioned acids [lower alkyl (C1-4) esters (such as methyl esters and ethyl esters), acid anhydrides, and the like].

Examples of an aliphatic dicarboxylic acid having a sulfo group include, but are not limited to, sulfosuccinic acid and sulfonates of ester-forming derivatives of sulfosuccinic acid [lower alkyl (C1-4) esters (such as methyl esters and ethyl esters), acid anhydrides, and the like].

Examples of sulfonate salts include, but are not limited to, salts of alkali metals (such as lithium, sodium, and potassium), salts of alkaline earth metals (such as magnesium and calcium), ammonium salts, amine salts such as mono-, di-, and tri-amines having hydroxyalkyl (C2-4) groups (organic amines salts such as mono-, di-, and triethylamine, mono-, di-, and triethanolamine, and diethylethanolamine), quaternary ammonium salts of these amines, and combinations of two or more of these components.

Among these, salts of 5-sulfoisophthalic acid are preferred, and 5-sulfoisophthalic acid sodium salt and 5-sulfoisophthalic acid potassium salt are particularly preferred.

(8) A method of manufacturing resin particles according to embodiments of the present invention is a method including a step of dissolving or dispersing a resin in an organic solvent to prepare a solution, a step of adding water to the solution to cause phase inversion from a water-in-oil dispersion liquid to an oil-in-water dispersion liquid, and an aggregation step of aggregating fine particles in the oil-in-water dispersion liquid by using an aggregating agent and terminating the aggregating at a predetermined time by using a terminating agent, in which the aggregating agent includes Mg as a divalent metal element.

(9) A method of manufacturing resin particles according to embodiments of the present invention is the method according to (8) described above, in which the terminating agent includes Na as a monovalent metal element.

(10) Embodiment of the present invention also provide a toner including the resin particles according to any one of (1) to (7) described above.

### (Amorphous Resin)

The resin particles preferably contain an amorphous resin.

The amorphous resin is preferably a terpene resin or an amorphous (non-crystalline) polyester resin (hereinafter also referred to as “amorphous polyester resin B”), and among these resins, a linear polyester resin is preferable, and further, an unmodified polyester resin is preferable. In the present embodiment, the amorphous resin refers to an amorphous resin other than PET and PBT.

The unmodified polyester resin is a polyester resin obtained by using a polyhydric alcohol and a polycarboxylic acid or a derivative thereof, such as polycarboxylic acids, polycarboxylic anhydrides, and polycarboxylic esters, and is not modified with an isocyanate compound or the like.

The amorphous polyester resin preferably does not contain a urethane bond or a urea bond.

The amorphous polyester resin contains a dicarboxylic acid component as a constituent component, and the dicarboxylic acid component preferably contains 50 mol % or more of terephthalic acid. This is advantageous from the viewpoint of heat-resistant storage stability.

Examples of the polyhydric alcohol include, but are not limited to, diols.

Examples of the diols include, but are not limited to, alkylene (number of carbon atoms from 2 to 3) oxide (average number of moles added: 1 to 10) adducts of bisphenol A such as polyoxypropylene (2.2)-2,2-bis(4-hydroxyphenyl) propane and polyoxyethylene (2.2)-2,2-bis(4-hydroxyphenyl) propane; ethylene glycol, neopentyl glycol, propylene glycol; hydrogenated bisphenol A, and alkylene (number of carbon atoms from 2 to 3) oxide (average number of moles added: 1 to 10) adducts of hydrogenated bisphenol A.

These diols may be used alone or in combination of two or more types.

Among these diols, plant-derived ethylene glycol and propylene glycol are preferred.

Examples of polycarboxylic acids include, but are not limited to, dicarboxylic acids.

Examples of dicarboxylic acids include, but are not limited to, adipic acid, phthalic acid, isophthalic acid, terephthalic acid, fumaric acid, maleic acid; succinic acids substituted with an alkyl group having 1 to 20 carbon atoms or an alkenyl group having 2 to 20 carbon atoms, such as dodecenylsuccinic acid and octylsuccinic acid; and modified purified rosin. The modified purified rosin is preferably rosin modified with acrylic acid, fumaric acid, or maleic acid.

Among these, succinic acid, which is a plant-derived saturated aliphatic acid, and modified purified rosin are preferable. If a plant-derived product is used, it is possible to improve the carbon neutrality. The saturated aliphatic group provides an effect of increasing the recrystallization properties of the crystalline polyester resin, and thus, the aspect ratio of the crystalline polyester resin increases, and the fixability at low temperatures improves.

These acids may be used alone or in combination of two or more types.

For the purpose of adjusting the acid value and the hydroxyl value, the amorphous polyester resin may contain at least one of a trivalent or higher carboxylic acid and a trihydric or higher alcohol at an end of a resin chain of the amorphous polyester resin.

Examples of trivalent or higher carboxylic acids include, but are not limited to, trimellitic acid, pyromellitic acid, and acid anhydrides thereof.

Examples of trihydric or higher alcohols include, but are not limited to, glycerin, pentaerythritol, and trimethylolpropane.

The molecular weight of the amorphous polyester resin is not particularly limited and can be appropriately selected according to a purpose. The weight average molecular weight (Mw) measured by gel permeation chromatography (GPC) is preferably from 3,000 to 10,000. The number average molecular weight (Mn) is preferably from 1,000 to 4,000. A ratio Mw/Mn of the weight average molecular weight (Mw) to the number average molecular weight (Mn) is preferably 1.0 to 4.0.

When the molecular weight is equal to or more than the above-mentioned lower limit, it is possible to suppress a decrease in the heat-resistant storage stability of the resin particles and in the durability against stress such as stirring in a developing device. When the molecular weight is equal to or less than the above-mentioned upper limit, it is possible to prevent an increases in the viscoelasticity of the resin particles when the resin particles are melted, and a decrease in the fixability at low temperatures.

The weight average molecular weight (Mw) is more preferably from 4,000 to 7,000. The number average molecular weight (Mn) is more preferably from 1,500 to 3,000. The ratio Mw/Mn of the weight average molecular weight (Mw) to the number average molecular weight (Mn) is more preferably from 1.0 to 3.5.

The acid value of the amorphous polyester resin is not particularly limited and can be appropriately selected according to a purpose. The acid value is preferably 1 mgKOH/g to 50 mgKOH/g, and more preferably 5 mgKOH/g to 30 mgKOH/g. When the acid value is 1 mgKOH/g or more, the resin particles easily take a negative charge, and further, when the resin particles are fixed to paper, the affinity between the paper and the resin particles is improved, so that the fixability at low temperatures can be improved. If the acid value is 50 mgKOH/g or less, it is possible to suppress a decrease in charging stability, particularly in charging stability relating to environmental fluctuations.

The hydroxyl value of the amorphous polyester resin is not particularly limited and may be appropriately selected according to a purpose, but is preferably 5 mgKOH/g or more.

The glass transition temperature (Tg) of the amorphous polyester resin is preferably from 40° C. to 80° C., and more preferably from 50° C. to 70° C. When the glass transition temperature (Tg) is 40° C. or higher, the resin particles have sufficient heat-resistant storage stability and durability against stress such as stirring in a developing device, and also have good filming resistance. When the glass transition temperature (Tg) is 80° C. or lower, the resin particles are sufficiently deformed by the application of heat and pressure during fixing, and thus, good fixability at low temperatures is obtained.

The molecular structure of the amorphous polyester resin can be confirmed by an NMR measurement of a solution or a solid, and further, by X-ray diffraction, GC/MS, LC/MS, and IR measurements. An example of a method includes, but is not limited to, a method of simply detecting, as an amorphous polyester resin, a resin that does not absorb at 965±10 cm⁻¹ and 990±10 cm⁻¹ from 8CH (out-of-plane bending vibration) of an olefin in an infrared absorption spectrum.

The content of the amorphous resin is not particularly limited and can be appropriately selected according to a purpose, but is preferably 50 parts by mass to 90 parts by mass, and more preferably 60 parts by mass to 80 parts by mass, with respect to 100 parts by mass of the resin particles. When the content of the amorphous resin is 50 parts by mass or more, it is possible to prevent a deterioration in the dispersibility of pigments and release agents in the resin particles, and suppress the occurrence of fogging and distortion of the image. When the content of the amorphous resin is 90 parts by mass or less, for example, the content of a crystalline polyester resin C described below and the content of the amorphous polyester resin B can be prevented from decreasing, and thus, it is possible to suppress a decrease in the fixability at low temperatures. When the content is within the above-mentioned more preferred range, it is advantageous in that both high image quality and excellent fixability at low temperatures can be obtained.

### (Prepolymer)

The resin particles may contain a non-crystalline resin (prepolymer) as the amorphous resin, to improve the fixability at low temperatures, and the prepolymer is preferably modified with an isocyanate compound or the like.

Examples of reactive precursors include, but are not limited to, polyesters having groups that can react with active hydrogen groups.

Examples of the groups that can react with active hydrogen groups include, but are not limited to, an isocyanate group, an epoxy group, a carboxylic acid, and an acid chloride group. Among these groups, an isocyanate group is preferred, because in this case, it is possible to introduce a urethane bond or a urea bond into the amorphous polyester resin.

The reactive precursor may have a branched structure imparted by at least one of a trihydric or higher alcohol and a trivalent or higher carboxylic acid.

Examples of a polyester resin containing an isocyanate group include, but are not limited to, a reaction product of a polyisocyanate with a polyester resin having an active hydrogen group (may be referred to as amorphous polyester resin A hereinafter).

For example, the polyester resin having an active hydrogen group may be obtained by polycondensation of a diol, a dicarboxylic acid, and at least one of a trihydric or higher alcohol and a trivalent or higher carboxylic acid. The trihydric or higher alcohol and the trivalent or higher carboxylic acid impart a branched structure to the polyester resin containing an isocyanate group.

Examples of the diol include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol; diols having an oxyalkylene group such as diethylene glycol, triethylene glycol, dipropylene glycol, polyethylene glycol, polypropylene glycol, and polytetramethylene glycol; alicyclic diols such as 1,4-cyclohexanedimethanol and hydrogenated bisphenol A; diol components obtained by adding alkylene oxides such as ethylene oxide, propylene oxide, and butylene oxide to alicyclic diols; bisphenols such as bisphenol A, bisphenol F, and bisphenol S; and alkylene oxide adducts of bisphenols obtained by adding alkylene oxides such as ethylene oxide, propylene oxide, and butylene oxide to bisphenols. Among these diols, from the viewpoint of controlling the glass transition temperature (Tg) of the amorphous polyester resin A to 20° C. or lower, it is preferable to use an aliphatic diol having 3 to 10 carbon atoms, such as 1,2-propylene glycol, 1,3-propylene glycol, 1,4-butanediol, 2-methyl-1,3-propanediol, 1,5-pentanediol, and 3-methyl-1,5-pentanediol, and it is more preferable to use 50 mol % or more of the alcohol component in the resin. These diols may be used alone or in combination of two or more types.

The amorphous polyester resin A has steric hindrance in the resin chain, which reduces the melt viscosity during fixing, and thus, it is easier to obtain fixability at low temperatures. Therefore, the main chain of the aliphatic diol preferably has a structure represented by General Formula (1) below.

HO—(CR1R2)n-OH General Formula (1)

In General Formula (1), R1 and R2 each independently represent a hydrogen atom and an alkyl group having 1 to 3 carbon atoms, respectively. n represents an odd number from 3 to 9. In the n repeating units, each of R1 and R2 may be the same or may be different.

Here, the main chain of the aliphatic diol refers to the carbon chain in which two hydroxyl groups contained in the aliphatic diol are linked via the lowest number of carbon atoms. It is preferable that the main chain has an odd number of carbon atoms, because in this case, the odd-even properties reduce crystallinity. Further, it is more preferable that the side chain has at least one or more alkyl groups having 1 to 3 carbon atoms, because in this case, the interaction energy between molecules in the main chain is reduced by the stereoscopic properties.

Examples of dicarboxylic acids include, but are not limited to, aliphatic dicarboxylic acids such as succinic acid, adipic acid, sebacic acid, dodecanedioic acid, maleic acid, and fumaric acid; and aromatic dicarboxylic acids such as phthalic acid, isophthalic acid, terephthalic acid, and naphthalenedicarboxylic acid. Further, anhydrides, lower (number of carbon atoms from 1 to 3) alkyl esters, and halides of these compounds may also be used. Among these, from the viewpoint of controlling the glass transition temperature (Tg) of the amorphous polyester resin A to 20° C. or lower, aliphatic dicarboxylic acids having 4 to 12 carbon atoms are preferred, and it is more preferable to use 50 mass % or more of these carboxylic acid components in the resin. These dicarboxylic acids may be used alone or in combination of two or more types.

Examples of the trihydric or higher alcohols include, but are not limited to, trihydric or higher aliphatic alcohols such as glycerin, trimethylolethane, trimethylolpropane, pentaerythritol, and sorbitol; trihydric or higher polyphenols such as trisphenol PA, phenol novolac, and cresol novolac; and alkylene oxide adducts of trihydric or higher polyphenols, such as adducts obtained by adding alkylene oxides such as ethylene oxide, propylene oxide, and butylene oxide to trihydric or higher polyphenols.

Examples of trivalent or higher carboxylic acids include, but are not limited to, trivalent or higher aromatic carboxylic acids, and preferred examples include, but are not limited to, trivalent or higher aromatic carboxylic acids having 9 to 20 carbon atoms, such as trimellitic acid and pyromellitic acid. Further, anhydrides, lower (number of carbon atoms from 1 to 3) alkyl esters, and halides of these compounds may also be used.

Examples of the polyisocyanate include, but are not limited to, diisocyanates and trivalent or higher isocyanates.

The polyisocyanate is not particularly limited and can be appropriately selected according to a purpose. Examples of the polyisocyanate include, but are not limited to, aromatic diisocyanates such as 1,3- and/or 1,4-phenylene diisocyanate, 2,4- and/or 2,6-tolylene diisocyanate (TDI), crude TDI, 2,4′- and/or 4,4′-diphenylmethane diisocyanate (MDI), crude MDI [a phosgenation product of crude diaminophenylmethane [a condensation product of formaldehyde with an aromatic amine (aniline) or a mixture thereof; a mixture of diaminodiphenylmethane and a small amount (for example, 5 to 20 mass %) of a trifunctional or higher functional polyamine]: polyallyl polyisocyanate (PAPI)], 1,5-naphthylene diisocyanate, 4,4′,4″-triphenylmethane triisocyanate, and m- and p-isocyanatophenylsulfonyl isocyanate; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; alicyclic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- and 2,6-norbornane diisocyanate; aromatic-aliphatic diisocyanates such as m- and p-xylylene diisocyanate (XDI) and α,α,α′,α′-tetramethylxylylene diisocyanate (TMXDI); trivalent or higher polyisocyanates such as lysine triisocyanate and modified products diisocyanates of trivalent or higher alcohols; and modified products of these isocyanates, and further, mixtures of two or more of these compounds may be used. Examples of the modified products of the isocyanates include, but are not limited to, modified products containing a urethane group, a carbodiimide group, an allophanate group, a urea group, a biuret group, a uretdione group, a uretimine group, an isocyanurate group, and an oxazolidone group.

### (Crystalline Resin)

The resin particles preferably contain a crystalline resin to improve the fixability at low temperatures.

The crystalline resin is not particularly limited and can be appropriately selected according to a purpose, as long as the crystalline resin has crystallinity. Examples of the crystalline resin include, but are not limited to, polyester resins, polyurethane resins, polyurea resins, polyamide resins, polyether resins, vinyl resins, and modified crystalline resins. These resins may be used alone or in combination of two or more types.

The polyester resin used as the crystalline resin is a crystalline polyester resin (may be referred to as “crystalline polyester resin C” hereinafter). The crystalline polyester resin C will be described below.

The crystalline polyester resin C has high crystallinity and therefore exhibits heat-melting properties including a rapid change in viscosity near a fixing start temperature.

By using the crystalline polyester resin C having the above-described characteristics together with the amorphous polyester resin B, it is possible to obtain resin particles having both good heat-resistant storage stability and fixability at low temperatures. For example, when the crystalline polyester resin C and the amorphous polyester resin B are used together, good heat-resistant storage stability is obtained by the crystallinity until a temperature immediately before the melting start temperature. At the melting start temperature, the melting of the crystalline polyester resin C causes a sudden decrease in viscosity (sharp melting property). As a result, the crystalline polyester resin C becomes compatible with the above-described amorphous polyester resin B, and both rapidly decrease in viscosity, which leads to good fixation.

### (Crystalline Polyester Resin)

The crystalline polyester resin may be obtained from a polyhydric alcohol and a polycarboxylic acid or a derivative thereof, such as a polycarboxylic acid, a polycarboxylic anhydride, and a polycarboxylic ester.

In the present embodiment, the crystalline polyester resin refers to a resin obtained by using, as described above, a polyhydric alcohol and a polycarboxylic acid or a derivative thereof, such as a polycarboxylic acid, a polycarboxylic anhydride, and a polycarboxylic ester. The crystalline polyester resin does not include resins obtained by modifying a polyester resins, such as prepolymers and resins obtained by subjecting the prepolymer to a cross-linking and/or an elongation reaction.

### ((Polyhydric Alcohol))

The polyhydric alcohol is not particularly limited and can be appropriately selected according to a purpose. Examples of the polyhydric alcohol include, but are not limited to, diols and trihydric or higher alcohols.

Examples of the diols include, but are not limited to, saturated aliphatic diols. Examples of the saturated aliphatic diols include, but are not limited to, linear saturated aliphatic diols and branched saturated aliphatic diols. Among these, linear saturated aliphatic diols are preferred, and linear saturated aliphatic diols having 2 to 12 carbon atoms are more preferred. When the saturated aliphatic diol has a branched structure, the crystallinity of the crystalline polyester resin decreases, and the melting point may decrease. Moreover, when the number of carbon atoms in the saturated aliphatic diol exceeds 12, it is difficult to acquire a material suitable for practical use.

Examples of the saturated aliphatic diols include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosane decanediol. Among these saturated aliphatic diols, ethylene glycol, 1,4-butanediol, 1,6-hexanediol, 1,8-octanediol, 1,9-nonanediol, 1,10-decanediol, and 1,12-dodecanediol are preferred to impart the crystalline polyester resin with high crystallinity and excellent sharp melting properties.

Examples of the trihydric or higher alcohol include, but are not limited to, glycerin, trimethylolethane, trimethylolpropane, and pentaerythritol. These alcohols may be used alone or in combination of two or more types.

### ((Polycarboxylic Acid))

The polycarboxylic acid is not particularly limited and can be appropriately selected according to a purpose. Examples of the polycarboxylic acid include, but are not limited to, divalent carboxylic acids and trivalent or higher carboxylic acids.

Examples of the divalent carboxylic acids include, but are not limited to, saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and aromatic dicarboxylic acids such as phthalic acid, isophthalic acid, terephthalic acid, naphthalene-2,6-dicarboxylic acid, malonic acid, and mesaconic acid. Further examples include, but are not limited to, anhydrides and lower (number of carbon atoms from 1 to 3) alkyl esters of these compounds. Among these, from the viewpoint of carbon neutrality, plant-derived saturated aliphatic compounds having 12 or less carbon atoms are preferred.

Examples of the trivalent or higher carboxylic acids include, but are not limited to, 1,2,4-benzenetricarboxylic acid, 1,2,5-benzenetricarboxylic acid, 1,2,4-naphthalenetricarboxylic acid, and further, anhydrides of these carboxylic acids and lower (number of carbon atoms from 1 to 3) alkyl esters of these carboxylic acids.

These carboxylic acids may be used alone or in combination of two or more types.

The crystalline polyester resin preferably includes a linear saturated aliphatic dicarboxylic acid having 4 to 12 carbon atoms and a linear saturated aliphatic diol having 2 to 12 carbon atoms. This provides high crystallinity and excellent sharp melting properties, and thus, it is possible to obtain excellent fixability at low temperatures. Further, an example of a method of controlling the crystallinity and the softening point of a crystalline polyester resin includes the following method. That is, the method includes designing and using a non-linear polyester and the like, obtained by adding a trivalent or higher polyhydric alcohol such as glycerin to the alcohol component, or a trivalent or higher polycarboxylic acid such as trimellitic anhydride to the acid component during polyester synthesis, and performing condensation polymerization.

The molecular structure of the crystalline polyester resin can be determined by an NMR measurement of a solution or a solid, and further, by X-ray diffraction, GC/MS, LC/MS, IR measurements, and the like. However, an example of a simple method includes a case where absorption from 8CH (out-of-plane bending vibration) of an olefin is observed at 965±10 cm⁻¹ or 990±10 cm⁻¹ in an infrared absorption spectrum.

Regarding the molecular weight, a crystalline polyester resin having the above-described sharp molecular weight distribution and a low molecular weight has excellent fixability at low temperatures, and a crystalline polyester resin having a large amount of components with low molecular weight has poor heat-resistant storage stability. Therefore, it is preferable that, in the molecular weight distribution of a fraction soluble in o-dichlorobenzene measured by GPC, in a molecular weight distribution diagram in which the horizontal axis is log (M) and the vertical axis is mass %, a peak position is in the range of 3.5 to 4.0, the full width at half maximum of the peak is 1.5 or less, the weight average molecular weight (Mw) is 3,000 to 30,000, the number average molecular weight (Mn) is 1,000 to 10,000, and the ratio Mw/Mn of the weight average molecular weight (Mw) to the number average molecular weight (Mn) is 1 to 10. It is more preferable that the weight average molecular weight (Mw) is 5,000 to 15,000, the number average molecular weight (Mn) is 2,000 to 10,000, and Mw/Mn is 1 to 5.

From the viewpoint of affinity between paper and the resin, the acid value of the crystalline polyester resin is preferably 5 mgKOH/g or more to achieve the desired fixability at low temperatures. In the preparation of fine particles by a phase inversion emulsification method, the acid value of the crystalline polyester resin is more preferably 7 mgKOH/g or more. On the other hand, to improve the hot offset properties, the acid value of the crystalline polyester resin is preferably 45 mgKOH/g or less.

The hydroxyl value of the crystalline polyester resin is preferably from 0 to 50 mgKOH/g, and more preferably from 5 to 50 mgKOH/g, to achieve a predetermined fixability at low temperatures and good charging characteristics.

The content of the crystalline polyester resin is not particularly limited and can be appropriately selected according to a purpose, but is preferably 5 parts by mass to 30 parts by mass, with respect to 100 parts by mass of the resin particles.

### (Other Components)

The resin particles may contain other components. Examples of the other components include, but are not limited to, wax, external additives, colorants, electrostatic charge control agents, cleanability improvers, and magnetic materials.

### (Wax)

The wax is not particularly limited and can be appropriately selected according to a purpose, but a release agent having a low melting point of 50° C. to 120° C. is preferred. When dispersed in the resin, the release agent having a low melting point effectively acts as a release agent at an interface between a fixing roller and the resin particles, so that good hot offset properties are obtained, even in an oil-less system (in which no release agent such as oil is applied to the fixing roller).

Suitable examples of the release agent include, but are not limited to, waxes. Examples of waxes include, but are not limited to, natural waxes including plant-based waxes such as carnauba wax, cotton wax, Japan wax, and rice wax; animal-based waxes such as beeswax and lanolin; mineral-based waxes such as ozokerite and cercine; and petroleum waxes such as paraffin, microcrystalline wax, and petrolatum. In addition to these natural waxes, examples of waxes include, but are not limited to, synthetic waxes including synthetic hydrocarbon waxes such as Fischer-Tropsch wax and polyethylene wax; esters, ketones, and ethers. Further, fatty acid amides such as 12-hydroxystearamide, stearamide, phthalimide anhydride, and chlorinated hydrocarbons; polyacrylate homopolymers or copolymers such as poly-n-stearyl methacrylate and poly-n-lauryl methacrylate, which are crystalline polymer resins having low molecular weight (for example, n-stearyl acrylate-ethyl methacrylate copolymer); and crystalline polymers having long alkyl groups in a side chain may also be used as the wax. These waxes may be used alone or in combination of two or more types.

From the viewpoint of reducing the environmental impact, plant-based waxes are preferred.

The melting point of the wax is not particularly limited and can be appropriately selected according to a purpose. However, the melting point is preferably 50° C. to 120° C., and more preferably 60° C. to 90° C. If the melting point is 50° C. or higher, it is possible to prevent a negative effect of the wax on the heat-resistant storage stability. If the melting point is 120° C. or lower, it is possible to effectively prevent cold offset during fixing at low temperatures. The melt viscosity of wax, obtained as a value measured at a temperature 20° C. higher than the melting point of the wax, is preferably 5 cps to 1,000 cps, and more preferably 10 cps to 100 cps. If the melt viscosity is 5 cps or more, it is possible to prevent a decrease of the releasability, and if the melt viscosity is 1,000 cps or less, the effects of hot offset resistance and fixability at low temperatures can be sufficiently exhibited. The content of the wax in the resin particles is not particularly limited and can be appropriately selected according to a purpose. However, the content is preferably 0 mass % to 40 mass %, and more preferably 3 mass % to 30 mass %.

### (External Additives)

Inorganic fine particles and polymeric fine particles can be used as external additives.

Examples of inorganic fine particles include, but are not limited to, silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Among these inorganic fine particles, silica, alumina, and titanium oxide are preferred.

The inorganic fine particles may be subjected to a surface treatment with a hydrophobic treatment agent to increase the hydrophobicity and prevent deterioration of flow characteristics and charging characteristics, even at high humidity. Preferred examples of the hydrophobic treatment agent include, but are not limited to, silane coupling agents, silylating agents, silane coupling agents having a fluorinated alkyl group, organic titanate coupling agents, aluminum-based coupling agents, silicone oil, and modified silicone oil.

Examples of the polymeric fine particles include, but are not limited to, polystyrene obtained by soap-free emulsion polymerization, suspension polymerization, and dispersion polymerization, polycondensation products such as methacrylic acid ester and acrylic ester copolymers, silicone, benzoguanamine, and nylon, and polymer particles formed of a thermosetting resin.

The average particle diameter of the primary particles of the inorganic fine particles is not particularly limited and can be appropriately selected according to a purpose, but is preferably 5 nm to 2 μm, and more preferably 10 nm to 500 nm. When the average particle diameter is 5 nm or more, the inorganic fine particles are prevented from aggregating, and the inorganic fine particles can be uniformly dispersed in the resin particles. If the average particle diameter is 2 μm or less, the heat-resistant storage stability can be improved by a filler effect.

The average particle diameter is a value obtained by directly determining the particle diameter from a picture obtained by a transmission electron microscope. It is preferable to observe at least 100 particles or more and use the average value of the major axes.

The specific surface area of the external additive measured by the BET method is preferably 20 to 500 m²/g.

The content of the external additives is preferably 0.01 mass % to 5 mass % of the resin particles.

### (Colorant)

As the colorant, known dyes and pigments can be used, and examples thereof include, but are not limited to, carbon black, nigrosine dye, iron black, Naphthol Yellow S, Hansa Yellow (10G, 5G, G), Cadmium Yellow, yellow iron oxide, ocher, chrome yellow, titanium yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazane Yellow BGL, Isoindolinone Yellow, red iron oxide, red lead, lead vermilion, Cadmium Red, Cadmium-Mercury Red, antimony vermilion, Permanent Red 4R, Para Red, Faise Red, Para-chloro-ortho-nitroaniline Red, Lithol Fast Scarlet G, Brilliant Fast Scarlet, Brilliant Carmine BS, Permanent Red (F2R, F4R, FRL, FRLL, F4RH), Fast Scarlet VD, Vulkan Fast Rubin B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red,

Polyazole Red, Chrome Vermilion, Benzidine Orange, Perinone Orange, Oil Orange, Cobalt Blue, Cerulean Blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), indigo, ultramarine blue, Prussian blue, Anthraquinone Blue, Fast Violet B, Methyl Violet Lake, cobalt violet, manganese violet, Dioxane Violet, Anthraquinone Violet, Chrome Green,

Zinc Green, chromium oxide, Viridian, Emerald Green, Pigment Green B, Naphthol Green B, Green Gold, Acid Green Lake, Malachite Green Lake, Phthalocyanine Green, Anthraquinone Green, titanium oxide, zinc white, and Lithopone, and mixtures of these colorants may be used.

### (Electrostatic Charge Control Agent)

The electrostatic charge control agent may be a typical electrostatic charge control agent, and examples of the electrostatic charge control agent include, but are not limited to, nigrosin-based dyes, triphenylmethane-based dyes, chromium-containing metal complex dyes, molybdate chelate pigments, rhodamine-based dyes, alkoxy-based amines, quaternary ammonium salts (including fluorine-modified quaternary ammonium salts), alkylamides, elemental phosphorus or phosphorus compounds, elemental tungsten or tungsten compounds, fluorine-based activators, metal salts of salicylic acid, and metal salts of salicylic acid derivatives. Specific examples of the electrostatic charge control agent include, but are not limited to, the nigrosin-based dye BONTRON 03, the quaternary ammonium salt BONTRON P-51, the metal-containing azo dye BONTRON S-34, the oxynaphthoic acid-based metal complex E-82, the salicylic acid-based metal complex E-84, the phenolic condensate E-89 (all manufactured by Orient Chemical Industries Co., Ltd.), the quaternary ammonium salt molybdenum complexes TP-302 and TP-415 (both manufactured by Hodogaya Chemical Co., Ltd.), the quaternary ammonium salt copy charge PSY VP2038, the triphenylmethane derivative copy blue PR, the quaternary ammonium salt copy charge NEG VP2036, and the copy charge NX VP434 (all manufactured by Hoechst AG), LRA-901 and the boron complex LR-147 (manufactured by Japan Carlit Co., Ltd.), copper phthalocyanine, perylene, quinacridone, azo pigments, and in addition, polymeric compounds having functional groups such as sulfonic acid groups, carboxyl groups, and quaternary ammonium salts. It is sufficient that the electrostatic charge control agent is used in an amount within a range in which the electrostatic charge control agent exhibits the performance without interfering with the fixability and the like. The electrostatic charge control agent is contained in the resin particles in an amount of 0.5 mass % to 5 mass %, and preferably 0.8 mass % to 3 mass %.

### (Cleanability Improver)

The cleanability improver is not particularly limited and can be appropriately selected according to a purpose, as long as the cleanability improver is a substance added to the resin particles to remove developer remaining on a photoconductor or a primary transfer body after transfer. Examples of the cleanability improver include, but are not limited to, fatty acid metal salts such as zinc stearate, calcium stearate, and stearic acid, and polymer fine particles prepared by soap-free emulsion polymerization such as polymethyl methacrylate fine particles, and polystyrene fine particles. The polymer particles preferably have a relatively narrow particle size distribution, and the volume average particle diameter is preferably from 0.01 μm to 1 μm.

### (Magnetic Material)

The magnetic material is not particularly limited and can be appropriately selected from known materials according to a purpose. Examples of the magnetic material include, but are not limited to, iron powder, magnetite, and ferrite. Among these magnetic materials, a magnetic material of white color is preferred in terms of color tone.

### <Characteristics of Resin Particles>

### (Particle Diameter of Resin Particles)

The particle diameter of the resin particles is measured by using a COULTER MULTISIZER III (manufactured by Coulter, Inc.). The particle diameter of the resin particles can be measured as described below. First, 2 mL of a surfactant (sodium dodecylbenzenesulfonate, manufactured by Tokyo Chemical Industry Co., Ltd.) is added as a dispersant to 100 mL of an electrolyte. The electrolyte may be an aqueous NaCl solution of about 1%, prepared by using first-grade sodium chloride, and ISOTON-II (manufactured by Coulter, Inc.) may be used. 10 mg of a measurement sample in terms of solid content is added to the mixture of the electrolyte and the surfactant, to obtain an electrolysis product in which the sample is suspended. The electrolyte in which the sample is suspended is subjected to a dispersion treatment using an ultrasonic disperser for about 1 to 3 minutes, and the volume and the number of the resin particles are measured by using a COULTER MULTISIZER III with an aperture of 100 μm, to calculate the volume distribution and the number distribution. From the obtained distribution, the volume average particle diameter (Dv) and the number average particle diameter (Dn) of the resin particles are determined.

In the present disclosure, the volume average particle diameter (Dv) of the resin particles is preferably from 4.5 to 7.5 μm, and more preferably from 5.0 to 6.0 μm. The ratio Dv/Dn of the volume average particle diameter (Dv) to the number average particle diameter (Dn) of the resin particles is preferably from 1.15 to 1.35, and more preferably from 1.20 to 1.30.

### [Method of Measuring Melting Point and Glass Transition Temperature (Tg)]

The melting point and the glass transition temperature (Tg) of the resin particles can be measured, for example, by using a differential scanning calorimeter (DSC) system (“Q-200”, manufactured by TA Instruments). Specifically, the melting point and the glass transition temperature of a target sample can be measured by the following procedure. First, about 5.0 mg of a target sample is filled into a sample container made of aluminum, and the sample container is placed on a holder unit and set in an electric furnace. Next, in a nitrogen atmosphere, the sample is heated from −80° C. to 150° C. at a heating rate of 10° C./min (first temperature increase). Afterwards, the sample is cooled from 150° C. to −80° C. at a cooling rate of 10° C./min, and then, heated again to 150° C. at a heating rate of 10° C./min (second temperature increase). During each of the first temperature increase and the second temperature increase, a DSC curve is measured by using a differential scanning calorimeter (“Q-200”, manufactured by TA Instruments). From the obtained DSC curves, the DSC curve at the first temperature increase can be selected by using an analysis program in the Q-200 system, to determine the glass transition temperature (Tg) of the target sample at the first temperature increase. Similarly, the DSC curve at the second temperature increase can be selected to determine the glass transition temperature (Tg) of the target sample at the second temperature increase.

Further, from the obtained DSC curves, the DSC curve during the first temperature increase can be selected by using the analysis program in the Q-200 system, to determine the endothermic peak top temperature at the first temperature increase of the target sample as the melting point. Similarly, the DSC curve at the second temperature increase can be selected, to determine the endothermic peak top temperature during the second temperature increase of the target sample as the melting point.

In the present specification, the endothermic peak top temperature and the glass transition temperature (Tg) during the second temperature increase are defined as the melting point and the glass transition temperature (Tg) of each target sample, that is, the glass transition temperature (Tg) and the melting points of the amorphous polyester resin A, the amorphous polyester resin B, the crystalline polyester resin C, and other constituent components such as a release agent, unless otherwise specified.

### [Average Particle Diameter and Average Circularity]

The average particle diameter and the average circularity can be measured by using, for example, a flow-type particle image analyzer (FPIA-3000, manufactured by Sysmex Corporation). In a specific measurement method, 100 ml to 150 ml of water from which solid impurities are removed in advance is filled into a container. 0.1 ml to 0.5 ml of a surfactant, preferably an alkylbenzene sulfonate salt, is added as a dispersant to the container, and then, about 0.1 g to 0.5 g of the measurement sample is added. The suspension liquid in which the sample is dispersed is subjected to a dispersion treatment for about 1 to 3 minutes by using an ultrasonic disperser. The average particle diameter and the average circularity are measured by using a flow-type particle image analyzer at a dispersion liquid concentration of 3000 particles/μl to 10000 particles/μl. The equivalent circle diameter is used as the particle diameter, and the average particle diameter is determined based on the equivalent circle diameter (number-based). The analysis conditions used in the flow-type particle image analyzer are listed below.
Particle diameter limits: 0.5 μm≤equivalent circle diameter (number-based)≤200.0 μm
Particle shape limits: 0.93<circularity≤1.00

The average circularity is defined as described below.

(Average circularity)=(circumference of a circle equal to projected area)/(circumference of projected image)

In the present embodiment, the average circularity of the resin particles is preferably from 0.960 to 0.975, and more preferably from 0.964 to 0.970.

### [Measurement of Molecular Weight]

The molecular weight of each constituent component of the resin particles can be measured by the following method, for example.
Gel permeation chromatography (GPC) measurement device: GPC-8220GPC (manufactured by Tosoh Corporation)
Column: TSKgel Super HZM-H 15 cm triple column (manufactured by Tosoh Corporation)
Temperature: 40° C.
Solvent: THF
Flow rate: 0.35 mL/min
Sample: 100 μL of 0.15 mass % sample injected
Pretreatment of sample: Resin particles are dissolved in tetrahydrofuran THF (containing a stabilizer, manufactured by Wako Pure Chemicals, Ltd.) at 0.15 mass %, and then, filtered through a 0.2 μm filter, to use the filtrate as a sample. 100 μL of the THF sample solution is injected and measured.

In measuring the molecular weight of the sample, the molecular weight distribution of the sample is calculated from the relationship between the count number and the logarithmic value of a calibration curve prepared by using several types of monodispersed polystyrene standard samples. SHODEX STANDARD of Std. No. S-7300, S-210, S-390, S-875, S-1980, S-10.9, S-629, S-3.0, and S-0.580 manufactured by Showa Denko K.K. are used as polystyrene standard samples for preparing the calibration curve. A refractive index (RI) detector is used as the detector.

### <Method of Manufacturing Resin Particles>

A method of manufacturing resin particles according to embodiments of the present invention will be described. The method of manufacturing resin particles includes an oil phase preparation step, an aqueous phase preparation step, a phase inversion emulsification step, a solvent removal step, an aggregation step, and a fusion step, and if desired, further includes other steps such as a shell formation step, a washing step, a drying step, an annealing step, and an external addition step.

### (Oil Phase Preparation Step)

In the oil phase preparation step, first, raw materials of the resin particles, that is, a resin (such as an amorphous resin, a non-crystalline resin, and a crystalline resin), and if desired, PET or PBT, and materials such as a colorant, a prepolymer (a precursor of the amorphous polyester resin A), and wax are dissolved or dispersed in an organic solvent to prepare an oil phase. A part of the material may be added in the aggregation step described below.

A method of preparing the oil phase is not particularly limited and can be appropriately selected according to a purpose. An example of the method includes a method in which a raw material such as a resin is gradually added to an organic solvent while stirring the organic solvent to dissolve or disperse the raw material.

To disperse the raw material, known dispersers such as a bead mill and a disk mill can be used.

The raw materials used in the oil phase preparation step may be the raw materials of the resin particles. These raw materials may be used alone or in combination of two or more types.

At least one of the resins (the amorphous resin, the non-crystalline resin, and the crystalline resin) is preferably a biomass-derived resin.

The organic solvent is not particularly limited and can be appropriately selected according to a purpose. However, it is preferable to use a volatile solvent having a boiling point of less than 100° C., because in this case, it is easier to subsequently remove the organic solvent.

Examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, butyl acetate, methyl ethyl ketone, methyl isobutyl ketone, methanol, ethanol, and isopropyl alcohol. These organic solvents may be used alone or in combination of two or more types.

When the resin to be dissolved or dispersed in the organic solvent is a resin having a polyester backbone, the organic solvent is preferably an ester-based solvent such as methyl acetate, ethyl acetate, and butyl acetate, or a ketone-based solvent such as methyl ethyl ketone and methyl isobutyl ketone, because in this case, the solubility is high. Among these, the organic solvent is preferably methyl acetate, ethyl acetate, or methyl ethyl ketone, because in this case, the organic solvent can be easily removed.

The amount of the organic solvent being used is not particularly limited and can be appropriately selected according to a purpose, but is preferably 40 parts by mass to 300 parts by mass, more preferably 60 parts by mass to 140 parts by mass, and even more preferably 80 parts by mass to 120 parts by mass, with respect to 100 parts by mass of the raw material of the resin particles.

### (Aqueous Phase Preparation Step)

In the aqueous phase preparation step, an aqueous phase (aqueous medium) is prepared.

The aqueous medium is not particularly limited and can be appropriately selected from known aqueous media. Examples of the aqueous medium include, but are not limited to, water, a solvent miscible with water, and a mixture of these. From the viewpoint of granulation properties, the concentration of the solvent miscible with water is preferably equal to or lower than the saturation concentration in ion-exchanged water used in the phase inversion emulsification step.

The solvent miscible with water is not particularly limited, can be appropriately selected from known solvents, and examples thereof include, but are not limited to, alcohol, dimethylformamide, tetrahydrofuran, CELLOSOLVE solvents, lower ketones, and esters.

Examples of the alcohol include, but are not limited to, methanol, isopropanol, and ethylene glycol.

Examples of lower ketones include, but are not limited to, acetone and methyl ethyl ketone.

Example of the esters include, but are not limited to, ethyl acetate.

These solvents may be used alone or in combination of two or more types.

### (Phase Inversion Emulsification Step)

In the phase inversion emulsification step, the oil phase obtained in the oil phase preparation step is formed into fine particles.

After neutralizing the oil phase, ion-exchanged water is added to the neutralized oil phase, and phase inversion emulsification, in which the water-in-oil dispersion liquid is inverted into an oil-in-water dispersion liquid, is used to obtain a fine particle dispersion liquid.

The phase inversion emulsification is implemented by stirring.

The phase inversion emulsification is implemented while uniformly mixing and dispersing the mixture by using a general-use stirrer or a dispersing device.

A stirring blade is not particularly limited and can be appropriately selected according to the viscosity of the solution. Examples of the stirring blade include, but are not limited to, stirring blades for low viscosity such as paddles and propellers, stirring blades for medium viscosity such as anchors and MAXBLEND stirring blades, and stirring blades for high viscosity such as helical ribbons.

The dispersing device is not particularly limited, and examples thereof include an ultrasonic disperser, a bead mill, a ball mill, a roll mill, a HOMO MIXER, an ULTRA MIXER, a disperser mixer, a penetrating-type high-pressure dispersion device, a collision-type high-pressure dispersion device, a multi-hole type high-pressure dispersion device, an ultra-high pressure homogenizer, and an ultrasonic homogenizer. A general-use stirrer and a dispersing device may be used in combination.

Among these dispersing devices, a paddle and an anchor are preferably used, because in this case, it is possible to control the volume average particle diameter of the dispersed body (oil droplets) within the above-mentioned preferred range.

As a base used for neutralizing the oil phase, any one of a basic inorganic compound or a basic organic compound may be used. Examples of the basic inorganic compound include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

When a stirring blade is used, the conditions such as the rotation speed, the stirring time, and the stirring temperature are not particularly limited and can be appropriately selected according to a purpose.

The rotation speed is not particularly limited, but is preferably 100 rpm to 1,000 rpm, and more preferably 200 rpm to 600 rpm.

The stirring time and the stirring temperature are not particularly limited and may be appropriately selected according to a purpose.

If desired, a dispersant may be used. The dispersant is not particularly limited and can be appropriately selected according to a purpose. Examples of the dispersant include, but are not limited to, surfactants, inorganic compound dispersants poorly soluble in water, and polymer-based protective colloids. These dispersants may be used alone or in combination of two or more types. Among these dispersants, surfactants are preferred.

The surfactants are not particularly limited, can be appropriately selected according to a purpose, and examples thereof include, but are not limited to, anionic surfactants, cationic surfactants, nonionic surfactants, and amphoteric surfactants.

The anionic surfactants are not particularly limited, can be appropriately selected according to a purpose, and examples thereof include, but are not limited to, alkylbenzene sulfonate, α-olefin sulfonate, and phosphoric acid ester. Among these anionic surfactants, surfactants having a fluoroalkyl group are preferred.

### (Solvent Removal Step)

In the solvent removal step, the organic solvent is removed from the obtained fine particle dispersion.

To remove the organic solvent from the obtained fine particle dispersion, a method can be adopted in which the temperature of the entire system is gradually increased, while the mixture is stirred, so that the organic solvent in the droplets is completely evaporated and removed.

Alternatively, the organic solvent in the droplets can be completely removed by spraying the obtained fine particle dispersion into a dry atmosphere while stirring the fine particle dispersion. Further, the organic solvent may be evaporated and removed by reducing the pressure while stirring the fine particle dispersion. Alternatively, the organic solvent may be evaporated and removed by blowing gas onto the fine particle dispersion while stirring the fine particle dispersion.

These members may be used alone or in combination.

The dry atmosphere into which the fine particle dispersion is sprayed is formed by a heated gaseous body such as air, nitrogen, carbon dioxide, and a combustion gas. In particular, various types of air streams heated to a temperature equal to or higher than the boiling point of the solvent having the highest boiling point are generally used as the dry atmosphere. Sufficient quality can be obtained by a short treatment such as using a spray dryer, a belt dryer, and a rotary kiln.

By removing the organic solvent from the obtained fine particle dispersion by the above-described method, a fine particle dispersion liquid can be obtained.

### (Aggregation Step)

In the aggregation step, the obtained fine particle dispersion liquid is stirred, while the particles are caused to aggregate to a desired particle diameter, and thus, aggregated particles are obtained.

To cause the particles to aggregate, existing methods such as adding an aggregating agent and adjusting the pH can be used. When an aggregating agent is added, the aggregating agent may be simply added. However, it is preferable to add the aggregating agent as an aqueous solution, because in this case, it is possible to prevent localized high concentration. It is also preferable to add the aggregating agent gradually while monitoring the particle diameter of the fine particles. It is preferable to use Mg as the aggregating agent and to perform the aggregation step under weak stirring. For example, methods may be adopted in which anchor blades having little vertical convection are used as the stirring blades to perform stirring at a peripheral speed of 0.5 m/s to 3.0 m/s, or a baffle is not provided in the stirring tank.

The temperature of the dispersion liquid during aggregation is preferably close to the glass transition temperature Tg of the resin being used. If the liquid temperature of the fine particle dispersion liquid is too low, the aggregation hardly proceeds, and thus, the efficiency is poor. If the liquid temperature of the fine particle dispersion liquid is too high, the aggregation rate increases, and thus, coarse particles are produced and the particle diameter distribution deteriorates.

When the desired particle diameter is obtained, the aggregation is terminated. Examples of a method of terminating the aggregation include a method of adding a salt having low ionic valence or a chelating agent, a method of adjusting the pH, a method of lowering the temperature of the dispersion liquid, and a method of adding a large amount of an aqueous medium to dilute the concentration. In the present embodiment, it is preferable to use Na as the terminating agent.

By using the above-described methods, it is possible to obtain a dispersion liquid of the resin particles.

In the aggregation step, a colorant, a crystalline resin, and a release agent may be added. In this case, the particles may be aggregated after mixing the particles with the above-described fine particle dispersion liquid or with a dispersion liquid obtained by dispersing a material in an aqueous medium, to obtain aggregated particles in which the colorant, the crystalline resin, and the release agent are uniformly dispersed.

In the present embodiment, it is preferable to use a metal salt of Na having low ionic valence. By replacing the metal used as the aggregating agent with Na, it is possible to efficiently terminate the aggregation.

### ((Aggregating Agent))

As the aggregating agent, a general aggregating agent can be used. The aggregating agent may be used alone or in combination of two or more types. However, in the present embodiment, it is preferable to use a divalent magnesium salt as the aggregating agent, as described above.

When a monovalent metal is used as the aggregating agent, the cross-linking effect is low. Further, when using a biomass resin, a non-crystalline resin having a large number of aromatic ring backbones, and a PET or PBT resin, the differences in the structure are large. If a trivalent or higher metal salt having a fast cross-linking reaction rate is used, the particle size distribution of the resin particles deteriorates. Among the divalent metals, especially Mg exhibited good aggregation properties. If a metal used in an aggregating agent or the like remains in the resin particles, the electrostatic properties deteriorate, and thus, the element amount of Mg in the resin particles is preferably 0.05 mass % or more and 0.30 mass % or less. In the present specification, mass % and % by mass have the same meaning. The type and the amount of metal in the resin particles can be adjusted by the type and the amount of the aggregating agent and the terminating agent, and the washing conditions in the washing step.

### (Fusion Step)

In the fusion step, the obtained aggregated particles are fused by a heating treatment to reduce the unevenness and obtain spherical particles. To fuse the aggregated particles, it is sufficient to heat the dispersion liquid of the aggregated particles while stirring the dispersion liquid. The temperature of the liquid is preferably close to a temperature higher than the glass transition temperature Tg of the resin being used.

A method of forming a shell layer is not particularly limited and can be appropriately selected according to a purpose. Examples of the method of forming the shell layer include, but are not limited to, a method in which spherical particles having a desired particle diameter are produced in a fusion step, and then, a non-crystalline resin is added, and the aggregation step and the fusion step are repeated to form the shell layer.

### (Washing and Drying Step)

In the washing and drying step, only the resin particles are extracted from the resin particle dispersion liquid obtained by the above-described method, and the resin particles are washed and dried.

The resin particle dispersion liquid obtained by the above-described method contains an auxiliary material such as an aggregating salt, in addition to the resin particles. Therefore, the resin particle dispersion liquid is washed to extract only the resin particles from the dispersion liquid. Methods of washing the resin particles are not particularly limited and examples thereof include a centrifugation method, a filtration method under reduced pressure, and a filter pressing method. All of the above-mentioned methods produce a cake body of the resin particles. If it is not possible to sufficiently wash the resin particles in one operation, the obtained cake may be dispersed again in an aqueous solvent to form a slurry, and the process of extracting the resin particles by any one of the above-mentioned methods may be repeated. Alternatively, if the filtration method under reduced pressure or the filter pressing method are used to wash the resin particles, a method may be adopted in which the aqueous solvent is passed through the cake to wash away auxiliary materials absorbed by colored resin particles. Examples of the aqueous solvent used to wash the resin particles include, but are not limited to, water and a mixed solvent obtained by mixing water with an alcohol such as methanol or ethanol. From the viewpoint of cost and environmental impact due to wastewater treatment, it is preferable to use water.

The washed resin particles contain a large amount of the aqueous medium, and thus, the aqueous medium may be removed by drying to obtain only the resin particles.

In the drying method, a dryer may be used, such as a spray dryer, a vacuum freeze dryer, a reduced pressure dryer, a stationary shelf dryer, a movable shelf dryer, a fluidized bed dryer, a rotary dryer, and an agitated dryer. The dried resin particles are preferably dried until the moisture content is finally reduced to less than 1%. If the colored resin particles after drying form soft agglomerates and are inconvenient for use, the soft agglomerates may be crushed by utilizing a device such as a jet mill, a Henschel mixer, a SUPER MIXER, a coffee mill, an OSTER blender, and a food processor to break up soft agglomerates.

### (Annealing Step)

In the annealing step, when a crystalline resin is added, the annealing treatment is performed after drying. Therefore, a non-crystalline resin and the crystalline resin are phase-separated, so that the fixability increases. Specifically, it is sufficient to store the material at a temperature close to the glass transition temperature Tg for 10 hours or more.

### (External Addition Step)

To impart fluidity, electrostatic properties, cleanability, and the like to the obtained resin particles, other components such as wax, external additives, colorants, electrostatic charge control agents, and cleanability improvers may be added to and mixed with the resin particles.

Specific mixing techniques include, but are not limited to, a method in which an impact force is applied to the mixture by a blade rotating at high speed, and a method in which the mixture is introduced into a high-speed air stream, accelerated, and the particles are caused to collide with each other or particles form composites that are caused to collide with an appropriate collision plate.

Examples of the device include, but are not limited to, ANGMILL (manufactured by Hosokawa Micron Corporation), a device obtained by modifying an I-type mill (manufactured by Nippon Pneumatic Mfg. Co., Ltd.) to reduce the pulverizing air pressure, a HYBRIDIZATION SYSTEM (manufactured by Nara Machinery, Co., Ltd.), a KRYPTRON SYSTEM (manufactured by Kawasaki Heavy Industries, Ltd.), and an automatic mortar.

### EXAMPLES

Examples of the present embodiment will be described below, but the present embodiment is not limited to the following examples in any way. In the following description, “parts” and “%” refer to “parts by mass” and “mass %”, respectively.

### <Synthesis of Amorphous Polyester Resin A-1>

A four-neck flask was equipped with a nitrogen inlet tube, a dehydration tube, a stirrer, and a thermocouple. Materials were filled into the flask so that a molar ratio of a 2 mol ethylene oxide adduct of bisphenol A/3 mol propylene oxide adduct of bisphenol A/biomass-derived propylene glycol was 40/55/5, a molar ratio of terephthalic acid/adipic acid was 50/50, and a ratio OH/COOH representing the molar ratio of hydroxyl groups and carboxyl groups was 1.3. The components were reacted with titanium tetraisopropoxide (500 ppm with respect to the resin components) at normal pressure and 230° C. for 8 hours. The mixture was further reacted for 4 hours at a reduced pressure of 10 mmHg to 15 mmHg. Subsequently, trimellitic anhydride was added to the reaction vessel in an amount of 1 mol % with respect to the total resin components, and the mixture was reacted at 18° C. and normal pressure for 3 hours to obtain [Amorphous Polyester Resin A-1].

### <Synthesis of Amorphous Polyester Resin A-2>

A four-neck flask was equipped with a nitrogen inlet tube, a dehydration tube, a stirrer, and a thermocouple. Materials were filled into the flask so that a molar ratio of a 2 mol ethylene oxide adduct of bisphenol A/3 mol propylene oxide adduct of bisphenol A/biomass-derived propylene glycol was 35/50/15, a molar ratio of terephthalic acid/adipic acid/biomass-derived succinic acid was 40/45/15, and the molar ratio of hydroxyl groups to carboxyl groups OH/COOH was 1.3. The components were reacted with titanium tetraisopropoxide (500 ppm with respect to the resin components) at normal pressure and 230° C. for 8 hours. The mixture was further reacted for 4 hours at a reduced pressure of 10 mmHg to 15 mmHg. Subsequently, trimellitic anhydride was added to the reaction vessel in an amount of 1 mol % with respect to the total resin components, and the mixture was reacted at 18° C. and normal pressure for 3 hours to obtain [Amorphous Polyester Resin A-2].

### <Synthesis of Amorphous Polyester Resin A-3>

A four-neck flask was equipped with a nitrogen inlet tube, a dehydration tube, a stirrer, and a thermocouple. Materials were filled into the flask so that a molar ratio of a 2 mol ethylene oxide adduct of bisphenol A/3 mol propylene oxide adduct of bisphenol A/flake-shaped recycled PET (in units of contained ethylene glycol units)/biomass-derived propylene glycol was 35/45/5/15, a molar ratio of flake-shaped recycled PET (in units of contained terephthalic acid units)/terephthalic acid/adipic acid/biomass-derived succinic acid was 5/40/40/15, and the molar ratio of hydroxyl groups to carboxyl groups OH/COOH was 1.3. The components were reacted with titanium tetraisopropoxide (500 ppm with respect to the resin components) at normal pressure and 230° C. for 8 hours. The mixture was further reacted for 4 hours at a reduced pressure of 10 mmHg to 15 mmHg. Subsequently, trimellitic anhydride was added to the reaction vessel in an amount of 1 mol % with respect to the total resin components, and the mixture was reacted at 18° C. and normal pressure for 3 hours to obtain [Amorphous Polyester Resin A-3].

### <Synthesis of Amorphous Polyester Resin A-4>

A four-neck flask was equipped with a nitrogen inlet tube, a dehydration tube, a stirrer, and a thermocouple. Materials were filled into the flask so that a molar ratio of a 2 mol ethylene oxide adduct of bisphenol A/3 mol propylene oxide adduct of bisphenol A/flake-shaped recycled PET (in units of contained ethylene glycol units)/biomass-derived propylene glycol was 25/30/30/15, a molar ratio of flake-shaped recycled PET (in units of contained terephthalic acid units)/terephthalic acid/adipic acid/biomass-derived succinic acid was 30/25/30/15, and the molar ratio of hydroxyl groups to carboxyl groups OH/COOH was 1.3. The components were reacted with titanium tetraisopropoxide (500 ppm with respect to the resin components) at normal pressure and 230° C. for 8 hours. The mixture was further reacted for 4 hours at a reduced pressure of 10 mmHg to 15 mmHg. Subsequently, trimellitic anhydride was added to the reaction vessel in an amount of 1 mol % with respect to the total resin components, and the mixture was reacted at 18° C. and normal pressure for 3 hours to obtain [Amorphous Polyester Resin A-4].

### <Synthesis of Amorphous Polyester Resin A-5>

A four-neck flask was equipped with a nitrogen inlet tube, a dehydration tube, a stirrer, and a thermocouple. Materials were filled into the flask so that a molar ratio of a 2 mol ethylene oxide adduct of bisphenol A/3 mol propylene oxide adduct of bisphenol A/flake-shaped recycled PET (in units of contained ethylene glycol units)/biomass-derived propylene glycol was 15/20/50/15, a molar ratio of flake-shaped recycled PET (in units of contained terephthalic acid units)/terephthalic acid/adipic acid/biomass-derived succinic acid was 50/15/20/15, and the molar ratio of hydroxyl groups to carboxyl groups OH/COOH was 1.3. The components were reacted with titanium tetraisopropoxide (500 ppm with respect to the resin components) at normal pressure and 230° C. for 8 hours. The mixture was further reacted for 4 hours at a reduced pressure of 10 mmHg to 15 mmHg. Subsequently, trimellitic anhydride was added to the reaction vessel in an amount of 1 mol % with respect to the total resin components, and the mixture was reacted at 18° C. and normal pressure for 3 hours to obtain [Amorphous Polyester Resin A-5].

### <Synthesis of Crystalline Polyester Resin C-1>

A 5 L four-neck flask was equipped with a nitrogen inlet tube, a dehydration tube, a stirrer, and a thermocouple. Plant-derived sebacic acid and 1,6-hexanediol were filled into the flask, so that the molar ratio of hydroxyl groups to carboxyl groups OH/COOH was 0.9, and reacted together with titanium tetraisopropoxide (500 ppm with respect to the resin components) at 180° C. for 10 hours. Subsequently, the temperature was raised to 200° C. and the mixture was reacted for 3 hours, and then, further reacted at a pressure of 8.3 kPa for 2 hours to obtain [Crystalline Polyester Resin C-1].

### <Preparation of Masterbatch (MB-1)>

1,200 parts of water, 500 parts of carbon black (PRINTEX 35, manufactured by Degussa AG) [DBP oil absorption amount=42 mL/100 mg, pH=9.5], and 500 parts of [Amorphous Polyester Resin A-1] were added to and mixed in a Henschel mixer (manufactured by Nippon Coke & Engineering Co., Ltd.). The obtained mixture was kneaded by using two rolls at 150° C. for 30 minutes, and then, rolled to cool, and pulverized in a pulverizer to obtain [Masterbatch MB-1].

### <Preparation of WAX Dispersion Liquid>

A container was equipped with a stirring rod and a thermometer. 42 parts of carnauba wax (RN-5, manufactured by Cerarica Noda Corporation, a plant-based wax, melting point of 82° C.) as a release agent and 420 parts of ethyl acetate were filled into the container. The temperature was raised to 80° C. while stirring, and the mixture was kept at 80° C. for 5 hours, and then, cooled to 30° C. during 1 hour. The mixture was dispersed by using a bead mill (ULTRAVISCOMILL, manufactured by AIMEX Co., Ltd.) under conditions including a liquid delivery rate of 1 kg/hr, a disk peripheral speed of 6 m/sec, addition of 80 vol % of zirconia beads having a diameter of 0.5 mm, and 3 repetitions to obtain [WAX Dispersion Liquid W-1]. The average particle diameter was 400 nm and the solid content concentration was 40%.

### <Preparation of Crystalline Polyester Dispersion Liquid>

A vessel was equipped with a stirring rod and a thermometer. 308 parts of [Crystalline Polyester Resin C-1] and 1900 parts of ethyl acetate were filled into the vessel. Subsequently, the temperature was raised to 80° C. while stirring, and after maintaining the temperature for 5 hours, the mixture was cooled to 30° C. in 1 hour. Further, 80 vol % of zirconia beads having a diameter of 0.5 mm were added and the mixture was dispersed by using an ULTRAVISCOMILL bead mill (manufactured by AIMEX Co., Ltd.) under conditions including three passes, to obtain [Crystalline Polyester Dispersion Liquid]. The volume average particle diameter was 450 nm and the solid content concentration was 11%.

### <Manufacturing Example of Sulfonate Group-Containing Resin S1>

A 5 L four-neck flask was equipped with a nitrogen inlet tube, a dehydration tube, a stirrer, and a thermocouple. 35 parts of a 2 mol ethylene oxide adduct of bisphenol A, 80 parts of a 2 mol propylene oxide adduct of bisphenol A, 30 parts of flake-shaped recycled PET (in units of contained ethylene glycol units), 10 parts of biomass-derived glycerol, 100 parts of flake-shaped recycled PET (in units of contained terephthalic acid units), 22 parts of biomass-derived succinic acid, and 12.3 parts of sodium 5-sulfoisophthalate were filled into the flask. As a condensation catalyst, 1000 ppm of tetrabutyl orthotitanate with respect to the total monomer amount was added to the flask, and the temperature was raised to 230° C. over 2 hours in a nitrogen stream. The mixture was allowed to react for 5 hours while distilling off the generated water.

Afterwards, the mixture was allowed to react for 4 hours under reduced pressure of 5 mmHg to 15 mmHg, and cooled to 180° C. Subsequently, 0.21 parts of trimellitic anhydride and 200 ppm of tetrabutyl orthotitanate with respect to the total monomer amount were added, and the mixture was allowed to react at normal pressure at 180° C. for 1 hour. Further, the mixture was allowed to react for 3 hours under reduced pressure of 5 mmHg to 20 mmHg to obtain a sulfonate group-containing resin S1.

### Example 1

### <Preparation of Oil Phase 1>

1589 parts of [WAX Dispersion Liquid], 1628 parts of [Amorphous Polyester Resin A-1], 1437 parts of [Crystalline Polyester Dispersion Liquid], 637 parts of ethyl acetate, and 557 parts of [Masterbatch] were added and stirred to dissolve and disperse the components. While stirring the mixture, 45 parts of ethyl acetate and 242 parts of a 10% aqueous sodium hydroxide solution were added to obtain [Oil Phase 1]. The obtained oil phase had a solid content of 50%.

### <Preparation of Aqueous Phase 1>

9283 parts of ion-exchanged water, 839 parts of ethyl acetate, and 520 parts of a surfactant (sodium dodecyl sulfate, solid content of 30%) were mixed and stirred to obtain [Aqueous Phase 1] having a milky white color.

### <Preparation of Core Emulsion 1>

The [Water Phase 1] was gradually added to [Oil Phase 1] to perform phase inversion emulsification. Afterwards, the solvent was removed to obtain [Core Emulsion 1]. The obtained core emulsion had a solid content of 20%.

### <Aggregation and Shell Formation Step>

15000 parts of [Core Emulsion 1] and 15000 parts of ion-exchanged water were filled into a vessel (without baffles and with anchor blades) and stirred for 5 minutes. Next, 1575 parts of a 10% aqueous magnesium sulfate solution was added dropwise and the mixture was further stirred for 5 minutes. Afterwards, the temperature was raised to 44° C. Subsequently, a particle diameter of 5.0 μm was obtained.

### <Termination and Fusion Step>

6696 parts of a 10% aqueous sodium sulfate solution were added, and the temperature was raised to 70° C. When the desired circularity of 0.960 to 0.970 was reached, the mixture was cooled to obtain [Dispersion Slurry 1].

### <Annealing Step, Cleaning and Drying Step>

The [Dispersion Slurry 1] was stored at 45° C. for 10 hours, and then, filtered under reduced pressure, and washed and dried as described below.
(1): 100 parts of ion-exchanged water was added to the filter cake, the mixture was mixed by using a TK HOMO MIXER (at a rotation speed of 12,000 rpm for 10 minutes) and then, the mixture was filtered.
(2): 900 parts of ion-exchanged water was added to the filter cake obtained in (1), the mixture was mixed in a TK HOMO MIXER (at a rotation speed of 12,000 rpm for 30 minutes) while applying ultrasonic vibration, and then, filtered under reduced pressure. This operation was repeated until the electric conductivity of the re-slurry liquid was 10 μC/cm or less, and then, the re-slurry liquid was filtered to obtain [Filter Cake 1]. The filtered cake was dried in a circulating air dryer at 45° C. for 48 hours and sieved through a mesh having openings of 75 μm to obtain [Toner Base Particles 1].

### <External Additive Treatment Step>

100 parts of [Toner Base Particles 1] and 2.0 parts of hydrophobic silica (HDK-2000, manufactured by Clariant AG) were mixed in a Henschel mixer, and the mixture was passed through a sieve having 500 mesh openings to obtain [Toner 1].

### Example 2

[Toner 2] was obtained similarly to Example 1, except that the amount of 10% magnesium sulfate was changed to 734 parts and the amount of 10% sodium sulfate was changed to 6822 parts in Example 1.

### Example 3

[Toner 3] was obtained similarly to Example 1, except that the amount of 10% magnesium sulfate was changed to 324 parts and the amount of 10% sodium sulfate was changed to 6883 parts in Example 1.

### Example 4

[Toner 4] was obtained similarly to Example 1, except that the amount of 10% magnesium sulfate was changed to 1180 parts and the amount of 10% sodium sulfate was changed to 6755 parts in Example 1.

### Example 5

[Toner 4] was obtained similarly to Example 1, except that the amount of 10% magnesium sulfate was changed to 734 parts and the amount of 10% sodium sulfate was changed to 3941 parts in Example 1.

### Example 6

[Toner 6] was obtained similarly to Example 1, except that the amount of 10% magnesium sulfate was changed to 324 parts and the amount of 10% sodium sulfate was changed to 1988 parts in Example 1.

### Example 7

[Toner 7] was obtained similarly to Example 1, except that the amount of 10% magnesium sulfate was changed to 1180 parts and the amount of 10% sodium sulfate was changed to 5704 parts in Example 1.

### Example 8

[Toner 8] was obtained similarly to Example 1, except that the [Amorphous Polyester Resin A-1] in Example 1 was changed to [Amorphous Polyester Resin A-2], the amount of 10% magnesium sulfate was changed to 734 parts and the amount of 10% sodium sulfate was changed to 3941 parts.

### Example 9

[Toner 9] was obtained similarly to Example 1, except that the [Amorphous Polyester Resin A-1] in Example 1 was changed to [Amorphous Polyester Resin A-3], the amount of 10% magnesium sulfate was changed to 734 parts and the amount of 10% sodium sulfate was changed to 3941 parts.

### Example 10

[Toner 10] was obtained similarly to Example 1, except that the [Amorphous Polyester Resin A-1] in Example 1 was changed to [Amorphous Polyester Resin A-4], the amount of 10% magnesium sulfate was changed to 734 parts and the amount of 10% sodium sulfate was changed to 3941 parts.

### Example 11

[Toner 11] was obtained similarly to Example 1, except that the [Amorphous Polyester Resin A-1] in Example 1 was changed to [Amorphous Polyester Resin A-5], the amount of 10% magnesium sulfate was changed to 734 parts and the amount of 10% sodium sulfate was changed to 3941 parts.

### Example 12

### <Preparation of Oil Phase 2>

1843 parts of [WAX Dispersion Liquid], 1412 parts of [Amorphous Polyester Resin A-1], 1667 parts of [Crystalline Polyester Dispersion Liquid], 637 parts of ethyl acetate, and 646 parts of [Masterbatch] were added and stirred to dissolve and disperse the components. While stirring the mixture, 45 parts of ethyl acetate and 242 parts of a 10% aqueous sodium hydroxide solution were added to obtain [Oil Phase 2]. The obtained oil phase had a solid content of 50%.

### <Preparation of Shell Emulsion 1>

### <Preparation of Shell Resin Solution 1>

4200 parts of [Sulfonate Group-Containing Resin S1] and 4200 parts of methyl ethyl ketone were filled into a container and mixed for 60 minutes at 5000 rpm by using a TK HOMO MIXER (manufactured by Primix Corporation) to obtain [Shell Resin Solution 1]. The obtained oil phase had a solid content of 50%.

### <Preparation of Shell Aqueous Phase 1>

9828 parts of ion-exchanged water and 2772 parts of methyl ethyl ketone were mixed and stirred to obtain [Shell Aqueous Phase 1].

### <Preparation of Shell Emulsion 1>

While stirring 8400 parts of [Shell Resin Solution 1] by using a TK HOMO MIXER at 8000 rpm, 124 parts of 28% aqueous ammonia was added to [Shell Resin Solution 1] and mixed for 10 minutes. Subsequently, 12600 parts of [Shell Aqueous Phase 1] was gradually added to subject the mixture to phase inversion emulsification. Afterwards, the solvent was removed to obtain [Shell Emulsion 1].

[Toner 12] was obtained similarly to Example 1, except that the oil phase 1 in Example 1 was changed to oil phase 2, the amount of 10% magnesium sulfate was changed to 1411 parts, the amount of 10% sodium sulfate was changed to 6605 parts, and 3968 parts of [Shell Emulsion 1] was added.

### Comparative Example 1

[Toner 13] was obtained similarly to Example 1, except that the amount of 10% magnesium sulfate was changed to 2025 parts and the amount of 10% sodium sulfate was changed to 5208 parts in Example 1.

The blending amounts of the above-described Examples are listed in Table 1.

### <Evaluation>

### (Fixability at High Temperatures)

A fixing unit of a color multifunction peripheral (IMAGIO MP C5503, manufactured by Ricoh Co., Ltd.) was used to form a solid black unfixed image having a density of 0.6 mg/cm² on plain paper. Subsequently, the image was fixed while changing the fixing temperature. The temperature at which hot offset occurred was measured, and evaluation was performed according to the evaluation criteria mentioned below.

### [Evaluation Criteria]

A: 190° C. or higher
B: 180° C. or higher and less than 190° C.
C.: 170° C. or higher and less than 180° C.
F: Less than 170° C.
A, B, and C are acceptable evaluation results.

### (Fixability at Low Temperatures)

A fixing unit of a color multifunction peripheral (IMAGIO MP C5503, manufactured by Ricoh Co., Ltd.) was used to form a solid black unfixed image having a density of 0.6 mg/cm² on plain paper. Subsequently, the image was fixed while changing the fixing temperature. The temperature at which cold offset occurred was measured, and evaluation was performed according to the evaluation criteria mentioned below.

### [Evaluation Criteria]

A: Less than 120° C.
B: 120° C. or higher and less than 125° C.
C: 125° C. or higher and less than 130° C.
F: 130° C. or higher
A, B, and C are acceptable evaluation results.

### (Electrostatic Properties)

6 g of a two-component developer was weighed and filled into a sealable metal cylinder. The developer was stirred at a stirring speed of 280 rpm, and the electrostatic charge amount was determined by a blow-off method. The measurement was performed at a stirring time of 60 seconds (TA60) and 600 seconds (TA600). TEFV200/300 (manufactured by Powdertech Co., Ltd.) was used as a carrier.
A: 36 or more
B: 33 or more and less than 36
C: 30 or more and less than 33
F: Less than 30
A, B, and C are acceptable evaluation results.

The evaluation results of the toner in the Examples and Comparative Examples are listed in Table 1. Table 1 also indicates the concentration of the radioactive carbon isotope ¹⁴C, Dv, Dv/Dn, and the circularity of the toner.

TABLE 1

| | | | | Example | Example | Example | Example | Example |
|---|---|---|---|---|---|---|---|---|
| | | | | 1 | 2 | 3 | 4 | 5 |
| Blending amount | Amorphous polyester resin | | — | A-1 | A-1 | A-1 | A-1 | A-1 |
| | Alcohol | Ethylene oxide | mol | 40 | 40 | 40 | 40 | 40 |
| | | of bisphenol A | | | | | | |
| | | Propylene oxide | mol | 55 | 55 | 55 | 55 | 55 |
| | | of bisphenol A | | | | | | |
| | | Ethylene glycol | mol | 0 | 0 | 0 | 0 | 0 |
| | | Propylene glycol | mol | 5 | 5 | 5 | 5 | 5 |
| | | Total | | 100 | 100 | 100 | 100 | 100 |
| | Acid | Terephthalic acid | mol | 0 | 0 | 0 | 0 | 0 |
| | | Terephthalic acid | mol | 50 | 50 | 50 | 50 | 50 |
| | | Adipic acid | mol | 50 | 50 | 50 | 50 | 50 |
| | | Succinic acid | mol | 0 | 0 | 0 | 0 | 0 |
| | | Total | | 100 | 100 | 100 | 100 | 100 |
| | Crystalline polyester dispersion | | — | C-1 | C-1 | C-1 | C-1 | C-1 |
| | liquid | | | | | | | |
| | Wax dispersion liquid | | — | W-1 | W-1 | W-1 | W-1 | W-1 |
| | Pigment masterbatch | | — | MB-1 | MB-1 | MB-1 | MB-1 | MB-1 |
| | Shell emulsion | | — | — | — | — | — | — |
| | Aggregating agent | | — | MgSO4 | MgSO4 | MgSO4 | MgSO4 | MgSO4 |
| | Terminating agent | | — | Na2SO4 | Na2SO4 | Na2SO4 | Na2SO4 | Na2SO4 |
| Amount added | Amorphous polyester resin | | Parts | 1,628 | 1,628 | 1,628 | 1,628 | 1,628 |
| | | | by mass | | | | | |
| | Crystalline polyester dispersion | | Parts | 1,437 | 1,437 | 1,437 | 1,437 | 1,437 |
| | liquid | | by mass | | | | | |
| | Wax dispersion liquid | | Parts | 1,589 | 1,589 | 1,589 | 1,589 | 1,589 |
| | | | by mass | | | | | |
| | Pigment masterbatch | | Parts | 557 | 557 | 557 | 557 | 557 |
| | | | by mass | | | | | |
| | Shell emulsion | | Parts | 0 | 0 | 0 | 0 | 0 |
| | | | by mass | | | | | |
| | Aggregating agent | | Parts | 1,575 | 734 | 324 | 1,180 | 734 |
| | | | by mass | | | | | |
| | Terminating agent | | Parts | 6,696 | 6,822 | 6,883 | 6,755 | 3,941 |
| | | | by mass | | | | | |
| Environmentally | Biomass ratio | | | 0 | 0 | 0 | 0 | 0 |
| friendly resin | PET ratio | | | 0 | 0 | 0 | 0 | 0 |
| Evaluation | 14C | | pMC | 0 | 0 | 0 | 0 | 0 |
| | X-ray | Mg | mass % | 0.35 | 0.16 | 0.07 | 0.26 | 0.16 |
| | fluorescence | Na | mass % | 0.45 | 0.45 | 0.45 | 0.45 | 0.26 |
| | | Total | mass % | 0.80 | 0.61 | 0.52 | 0.71 | 0.42 |
| | Fixability at low temperatures | | — | C | B | B | B | B |
| | Fixability at high temperatures | | — | A | B | C | B | B |
| | Electrostatic | TA60 | — | C | B | B | C | B |
| | properties | TA600 | — | C | B | B | C | B |
| | Particle diameter Dv | | μm | 5.2 | 5.2 | 5.2 | 5.2 | 5.2 |
| | Particle size | Dv/Dn | — | 1.30 | 1.20 | 1.30 | 1.25 | 1.20 |
| | distribution | | | | | | | |
| | Circularity | | — | 0.964 | 0.964 | 0.964 | 0.964 | 0.968 |
| | | | | Example | Example | Example | Example | Example |
| | | | | 6 | 7 | 8 | 9 | 10 |
| Blending amount | Amorphous polyester resin | | — | A-1 | A-1 | A-2 | A-3 | A-4 |
| | Alcohol | Ethylene oxide | mol | 40 | 40 | 35 | 35 | 25 |
| | | of bisphenol A | | | | | | |
| | | Propylene oxide | mol | 55 | 55 | 50 | 45 | 30 |
| | | of bisphenol A | | | | | | |
| | | Ethylene glycol | mol | 0 | 0 | 0 | 5 | 30 |
| | | Propylene glycol | mol | 5 | 5 | 15 | 15 | 15 |
| | | Total | | 100 | 100 | 100 | 100 | 100 |
| | Acid | Terephthalic acid | mol | 0 | 0 | 0 | 5 | 30 |
| | | Terephthalic acid | mol | 50 | 50 | 40 | 40 | 25 |
| | | Adipic acid | mol | 50 | 50 | 45 | 40 | 30 |
| | | Succinic acid | mol | 0 | 0 | 15 | 15 | 15 |
| | | Total | | 100 | 100 | 100 | 100 | 100 |
| | Crystalline polyester dispersion | | — | C-1 | C-1 | C-1 | C-1 | C-1 |
| | liquid | | | | | | | |
| | Wax dispersion liquid | | — | W-1 | W-1 | W-1 | W-1 | W-1 |
| | Pigment masterbatch | | — | MB-1 | MB-1 | MB-1 | MB-1 | MB-1 |
| | Shell emulsion | | — | — | — | — | — | — |
| | Aggregating agent | | — | MgSO4 | MgSO4 | MgSO4 | MgSO4 | MgSO4 |
| | Terminating agent | | — | Na2SO4 | Na2SO4 | Na2SO4 | Na2SO4 | Na2SO4 |
| Amount added | Amorphous polyester resin | | Parts | 1,628 | 1,628 | 1,628 | 1,628 | 1,628 |
| | | | by mass | | | | | |
| | Crystalline polyester dispersion | | Parts | 1,437 | 1,437 | 1,437 | 1,437 | 1,437 |
| | liquid | | by mass | | | | | |
| | Wax dispersion liquid | | Parts | 1,589 | 1,589 | 1,589 | 1,589 | 1,589 |
| | | | by mass | | | | | |
| | Pigment masterbatch | | Parts | 557 | 557 | 557 | 557 | 557 |
| | | | by mass | | | | | |
| | Shell emulsion | | Parts | 0 | 0 | 0 | 0 | 0 |
| | | | by mass | | | | | |
| | Aggregating agent | | Parts | 324 | 1,180 | 734 | 734 | 734 |
| | | | by mass | | | | | |
| | Terminating agent | | Parts | 1,988 | 5,704 | 3,941 | 3,941 | 3,941 |
| | | | by mass | | | | | |
| Environmentally | Biomass ratio | | | 0 | 0 | 15 | 15 | 15 |
| friendly resin | PET ratio | | | 0 | 0 | 0 | 10 | 30 |
| Evaluation | 14C | | pMC | 0 | 0 | 16 | 16 | 16 |
| | X-ray | Mg | mass % | 0.07 | 0.26 | 0.16 | 0.16 | 0.16 |
| | fluorescence | Na | mass % | 0.13 | 0.38 | 0.26 | 0.26 | 0.26 |
| | | Total | mass % | 0.20 | 0.64 | 0.42 | 0.42 | 0.42 |
| | Fixability at low temperatures | | — | A | B | B | B | B |
| | Fixability at high temperatures | | — | C | B | B | B | B |
| | Electrostatic | TA60 | — | A | C | B | B | B |
| | properties | TA600 | — | A | C | B | B | B |
| | Particle diameter Dv | | μm | 5.2 | 5.2 | 5.2 | 5.2 | 5.2 |
| | Particle size | Dv/Dn | — | 1.30 | 1.25 | 1.20 | 1.20 | 1.20 |
| | distribution | | | | | | | |

| | | | | | | |
|---|---|---|---|---|---|---|
| Circularity | — | 0.970 | 0.965 | 0.968 | 0.968 | 0.968 |

| | | | Example | Example | Comparative |
|---|---|---|---|---|---|
| | | | 11 | 12 | Example 1 |
| Blending amount | Amorphous polyester resin | — | A-5 | A-1 | A-1 |

| | | | | | |
|---|---|---|---|---|---|
| Alcohol | Ethylene oxide | mol | 15 | 40 | 40 |
| | of bisphenol A | | | | |
| | Propylene oxide | mol | 20 | 55 | 55 |
| | of bisphenol A | | | | |
| | Ethylene glycol | mol | 50 | 0 | 0 |
| | Propylene glycol | mol | 15 | 5 | 5 |
| | Total | | 100 | 100 | 100 |
| Acid | Terephthalic acid | mol | 50 | 0 | 0 |
| | Terephthalic acid | mol | 15 | 50 | 50 |
| | Adipic acid | mol | 20 | 50 | 50 |
| | Succinic acid | mol | 15 | 0 | 0 |
| | Total | | 100 | 100 | 100 |

| | | | | | |
|---|---|---|---|---|---|
| | Crystalline polyester dispersion | — | C-1 | C-1 | C-1 |
| | liquid | | | | |
| | Wax dispersion liquid | — | W-1 | W-1 | W-1 |
| | Pigment masterbatch | — | MB-1 | MB-1 | MB-1 |
| | Shell emulsion | — | — | S-1 | — |
| | Aggregating agent | — | MgSO4 | MgSO4 | MgSO4 |
| | Terminating agent | — | Na2SO4 | Na2SO4 | Na2SO4 |
| Amount added | Amorphous polyester resin | Parts | 1,628 | 1,412 | 1,628 |
| | | by mass | | | |
| | Crystalline polyester dispersion | Parts | 1,437 | 1,667 | 1,437 |
| | liquid | by mass | | | |
| | Wax dispersion liquid | Parts | 1,589 | 1,843 | 1,589 |
| | | by mass | | | |
| | Pigment masterbatch | Parts | 557 | 646 | 557 |
| | | by mass | | | |
| | Shell emulsion | Parts | 0 | 3,968 | 0 |
| | | by mass | | | |
| | Aggregating agent | Parts | 734 | 1,411 | 2,025 |
| | | by mass | | | |
| | Terminating agent | Parts | 3,941 | 6,605 | 5,208 |
| | | by mass | | | |
| Environmentally | Biomass ratio | | 15 | 5 | 5 |
| friendly resin | PET ratio | | 50 | 0 | 0 |
| Evaluation | 14C | pMC | 16 | 6 | 6 |

| X-ray | Mg | mass % | 0.16 | 0.35 | 0.45 |
|---|---|---|---|---|---|
| fluorescence | Na | mass % | 0.26 | 0.45 | 0.35 |
| | Total | mass % | 0.42 | 0.80 | 0.80 |
| Fixability at low temperatures | | — | B | C | F |
| Fixability at high temperatures | | — | B | A | C |
| Electrostatic | TA60 | — | B | B | F |
| properties | TA600 | — | B | B | F |
| Particle diameter Dv | | μm | 5.2 | 5.2 | 7.8 |
| Particle size | Dv/Dn | — | 1.20 | 1.30 | 1.60 |
| distribution | | | | | |

| | | | | |
|---|---|---|---|---|
| Circularity | — | 0.968 | 0.964 | 0.900 |

Aspects of the present invention include the following, for example.

According to a first aspect, resin particles contain Mg and Na as metal elements, and
a Mg content in the resin particles measured by fluorescent X-ray analysis is lower than a Na content in the resin particles measured by fluorescent X-ray analysis.

According to a second aspect, in the resin particles according to the first aspect, the Mg content in the resin particles is 0.05 mass % or more and 0.30 mass % or less.

According to a third aspect, in the resin particles according to the first aspect or the second aspect, the Na content in the resin particles is 0.10 mass % or more and 0.40 mass % or less.

According to a fourth aspect, in the resin particles according to any one of the first aspect to the third aspect, a concentration of radioactive carbon isotope ¹⁴C in the resin particles is 10.8 pMC or more.

According to a fifth aspect, in the resin particles according to any one of the first aspect to the fourth aspect, the resin particles contain polyethylene terephthalate or polybutylene terephthalate.

According to a sixth aspect, in the resin particles according to any one of the first aspect to the fifth aspect, the resin particles further contain a biomass-derived resin and polyethylene terephthalate or the polybutylene terephthalate, and a content of the polyethylene terephthalate or the polybutylene terephthalate in the resin particles is greater than a content of the biomass-derived resin.

According to a seventh aspect, in the resin particles according to any one of the first aspect to the sixth aspect, the resin particles have a core-shell structure, and the core-shell structure includes a shell layer including at least a sulfonate group.

According to an eighth aspect, a method of manufacturing the resin particles according to any one of the first aspect to the seventh aspect includes
dissolving or dispersing a resin in an organic solvent to prepare a solution, adding water to the solution to cause phase inversion from a water-in-oil dispersion liquid to an oil-in-water dispersion liquid, and aggregating fine particles in the oil-in-water dispersion liquid by using an aggregating agent including magnesium as a divalent metal element and terminating the aggregating at a predetermined time by using a terminating agent.

According to a ninth aspect, in the manufacturing method of the resin particles according to the eighth aspect, the terminating agent includes Na as a monovalent metal element.

According to a tenth aspect, a toner includes the resin particles according to any one of the first aspect to the seventh aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. Resin particles comprising:
magnesium and sodium as metal elements,
a magnesium content in the resin particles measured by fluorescent X-ray analysis being lower than a sodium content in the resin particles measured by the fluorescent X-ray analysis.

2. The resin particles according to claim 1, wherein the magnesium content in the resin particles is 0.05 mass % or more and 0.30 mass % or less.

3. The resin particles according to claim 1, wherein the sodium content in the resin particles is 0.10 mass % or more and 0.40 mass % or less.

4. The resin particles according to claim 1, wherein a concentration of radioactive carbon isotope ¹⁴C in the resin particles is 10.8 pMC or more.

5. The resin particles according to claim 1, wherein the resin particles further comprise at least one of polyethylene terephthalate or polybutylene terephthalate.

6. The resin particles according to claim 1, wherein the resin particles further comprise a biomass-derived resin and at least one of polyethylene terephthalate or polybutylene terephthalate, and
a content of the at least one of polyethylene terephthalate or polybutylene terephthalate in the resin particles is greater than a content of the biomass-derived resin.

7. The resin particles according to claim 1, wherein the resin particles have a core-shell structure, and the core-shell structure includes a shell layer including a sulfonate group.

8. A method of manufacturing the resin particles according to claim 1, the method comprising:
dissolving or dispersing a resin in an organic solvent to prepare a solution;
adding water to the solution to cause phase inversion from a water-in-oil dispersion liquid to an oil-in-water dispersion liquid; and
aggregating fine particles in the oil-in-water dispersion liquid by using an aggregating agent including magnesium as a divalent metal element and terminating the aggregating at a predetermined time by using a terminating agent.

9. The method according to claim 8, wherein the terminating agent includes sodium as a monovalent metal element.

10. A toner comprising the resin particles according to claim 1.
